(19) United States
(12) Patent Application Publication
(10) Pub. No.: US 2018/0051099 A1
(43) Pub. Date: Feb. 22, 2018

(54) Processes to Prepare Highly Functional Fiber Products and Products Produced Thereby

(71) Applicants: The United States of America, as Represented by the Secretary of Agriculture, Washington, DC (US); Z-Trim Holdings Inc., Mundelein, IL (US)

(72) Inventors: Madhav P. Yadav, North Wales, PA (US); Arland T. Hotchkiss, Ambler, PA (US); Kyle Hanah, Mount Prospect, IL (US); Madhuvanti Kale, Flourtown, PA (US)

(21) Appl. No.: 15/240,702

(22) Filed: Aug. 18, 2016

(51) Int. Cl. C08B 37/00; C08B 15/08

(52) U.S. Cl. CPC C08B 37/0048; C08B 15/08

(57) ABSTRACT

Processes to prepare highly functional fiber products from agricultural by-products (e.g., sugar beet pulp, orange peel, apple pulp and other pectin containing agricultural processing by-products) and their applications are disclosed. Sequential extraction of pectin from agricultural by-products produced a series of fractions with excellent oil in water emulsification and water holding capacity properties.

### BACKGROUND OF THE INVENTION

Dietary fiber is that carbohydrate portion of food that is not digested in the stomach and small intestine, and which passes through to the colon where it may undergo fermentation. Non-starch polysaccharides derived from plant cell walls are present in cereals, fruits and vegetables in our diet and play a large role in selecting the colonic microbial population composition, and are known to reduce the risk of chronic diseases such as diabetes, cancer, and cardiovascular disease (Gibson and Roberfroid, J. Nutr., 125: 1401-1412 (1995); Jacobs, D. R., and D. D. Gallaher, Curr. Atheroscler. Rep., 6: 415-423 (2004); Jemal, A., et al., JAMA, 294: 1255-1259 (2005); Dikeman, C. L., and G. C. Fahey, Crit. Rev. Food Sci. Nutr., 46: 649-663 (2006)). The connection between health and the food we eat has led consumers to demand more healthy food ingredients. The physiochemical and functional properties of dietary fiber play a large role in determining their health benefits (Collins, H. M., et al., Cereal Chem., 87: 272-282 (2010)).

Commercial ZTrim is an insoluble cellulosic fiber produced by alkaline treatment of corn fiber and oat hulls that can replace fat, hold water, serve as an emulsifier, and control syneresis in food products (Z-Trim Holdings, Inc., now Agritech Worldwide) (http://www.ztrim.com/). Corn fiber arabinoxylan (also called corn fiber gum) was prepared by alkaline hydrogen peroxide extraction (Doner and Hicks, Cereal Chem., 74: 176-181 (1997); Doner et al., Cereal Chem., 75: 408-411 (1998); Yadav et al., Foods and Food Ingredients Journal, 211: 245-252 (2006); Yadav, M. P., et al., Cereal Chemistry, 87(2): 89-94 (2010)), and this fiber was a good substitute for gum arabic based on its oil-in-water emulsifier properties (Yadav, M. P., et al., Food Hydrocolloids, 21: 1022-1030 (2007a); Yadav, M. P., et al., J. Agric. Food Chem., 55: 6366-6371 (2007b); Yadav, M. P., et al., Food Hydrocolloids, 53: 125-133 (2010)). An arabinoxylan-rich fiber (bio-based fiber gum) was also developed from corn bran and oat hull alkaline processing streams using an alkaline extraction process that had emulsifier and binding agent properties in petroleum coke pellets (Yadav et al., Food Hydrocolloids, 53: 125-133 (2016)).

Citrus fiber, which consists of mostly pectin with lower amounts of cellulose and hemicellulose, has water-holding properties in food products (Lundberg et al., J. Food Engineering, 125: 97-104 (2014)). Sugar beet fiber that also contains hemicellulose, cellulose, and pectin with high water holding capacity was approved for a digestive health claim by the European Commission (Nordic Sugar A/S; http://www.nordicsugar.com/industry/fibrexr-sugar-beet-fibre/). Sugar beets were extracted with acid and alkali to produce pectin (Fishman, M. L., et al., J. Agric. Food Chem., 56: 1471-1478 (2008); Guillon and Thibault, Lebensmittel Wissenschaft Technol., 21: 198-205 (1988); Sun and Hughes, Carbohydr. Polymers, 36: 293-299 (1998); Marry et al., J. Sci. Food Agric., 80: 17-28 (2000), alkaline soluble polysaccharides (Fishman, M. L., et al., Food Hydrocolloids, 23: 1554-1562 (2009); Sun and Hughes, Carbohydr. Polymers, 38: 273-281 (1999)), and cellulose (Fishman et al., Cellulose 18: 787-801 (2011); Sun and Hughes, Carbohydr. Polymers, 36: 293-299 (1998); Dinard et al., Food Hydrocolloids, 13: 275-283 (1999)). The sugar beet alkaline soluble polysaccharides were low molecular weight pectins that served as emulsifiers (Fishman et al. 2009; Leroux et al., Food Hydrocolloids, 17: 455-462 (2003); Williams et al., J. Agric. Food Chem., 53, 3592-3597 (2005)). Sugar beet cellulose has liquid crystalline, nanofibillar properties that have been used to reinforce composite materials (Dinard et al., Food Hydrocolloids, 13: 275-283 (1999); Weibel and Meyers, U.S. Pat. No. 4,923,981 (1990); Sun and Hughes, Carbohydr. Polymers, 36: 293-299 (1998); Leitner et al., Cellulose, 14:419-425 (2007)). Carboxymethyl-cellulose has also been produced from sugar beet cellulose (Fishman et al. 2011; Togru, H., and N. Arslan, Carbohydrate Polymers, 54: 63-71 (2003)) which was used in Mandarin orange coatings that extended their shelf life (Togru and Arslan, J. Food Eng., 62: 271-279 (2004)). Citrus and sugar beet pectic oligosaccharides also have potential as prebiotics (Manderson et al., Appl. Environ. Microbiol., 71: 8383-8389 (2005); Holck et al., J. Agric. Food Chem., 59: 6511-6519 (2011); Hotchkiss et al., 2012, U.S. Pat. No. 8,313,789)).

We have developed processes with minimum processing to prepare highly functional fiber products from pectin containing agricultural processing by-products (e.g., sugar beet pulp, orange peel, apple fiber) and their applications.

### SUMMARY OF THE INVENTION

A process for making pectin F1, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (both low and high MW carbohydrates),

(4) adding water to said dry product to form a suspension and adjusting the pH of said suspension to about 1.6 (e.g., using acid like HCl),

(5) heating said suspension (e.g., at about 70° to about 100° C.; about 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) combining said washings and said acid extracted filtrate to form combined filtrate and washings and adjusting the pH of said combined filtrate and washings to about 3 to about 3.2 (e.g., with base like NaOH), and

(9) adding alcohol (e.g., ethanol, isopropanol) to said combined filtrate and washings to precipitate said pectin F1, and

(10) isolating said pectin F1 (e.g., by filtration).

Pectin F1, said pectin F1 produced by the above process.

A process for making pectin F2, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., 70° to 100° C.; 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3, and

(13) adjusting the pH of said alkali solubilized fraction to about 4 (precipitates F2) to form pectin F2, and

(14) isolating (e.g., centrifuging and/or filtering; supernatant or filtrate contains F3) pectin F2.

Pectin F2, said pectin F2 produced by the above process.

A process for making pectin F3, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., about 70 to about 100° C.; about 90° C.) with stirring (e.g., for about 1 to about 5 hours, about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifuging at about 14,000×g for about 10 minutes) said slurry into an alkali insoluble solid residue (used to isolate F4) and an alkali solubilized fraction which contains pectin F2 and pectin F3, and

(13) adjusting the pH of said alkali solubilized fraction to about 4 which precipitates pectin F2, and

(14) isolating (e.g., centrifuging and/or filtering; supernatant or filtrate contains F3) pectin F3 from the supernatant or filtrate obtained from pectin F2 collection.

Pectin F3, said pectin F3 produced by the above process.

A process for making acid and alkali soluble (low molecular weighty materials (via process that makes Pectin F3), said process comprising:

(1) removing oil from an agricultural by-product (e.g., orange peel; milled) to form a de-oiled biomass,

(2) adding hot water (e.g., about 75° to about 100° C.; about 90° C.; about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., at about 70 to 100° C.; about 90° C.) with stirring (e.g., for about 1 to about 5 hours; 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3,

(13) adjusting the pH of said alkali solubilized fraction to about 4 (which precipitates pectin F2),

(14) centrifuging or filtering said alkali solubilized fraction to separate and isolate pectin F2 from the supernatant or filtrate containing pectin F3,

(15) adding alcohol (e.g., ethanol, isopropanol) to said supernatant or filtrate to form a first precipitate (F3) and first decantant,

(16) removing said first precipitate and adding alcohol (e.g., ethanol, isopropanol) to form a second precipitate (F3) and second decantant, and

(17) combining said first decantant and said second decantant which contains said acid and alkali soluble materials.

Acid and alkali soluble (low molecular weight) materials, said acid and alkali soluble low molecular weight materials produced by the above process.

A process for making cellulosic fraction F4, said process comprising:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., at about 70 to about 100° C.; about 90° C.) with stirring (e.g., for about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3,

(13) suspending said alkali insoluble solid residue in boiling water and stirring (e.g., for about 5 minutes),

(14) shearing (e.g., at about 10,000 rpm for about 5 minutes) said alkali insoluble solid residue to formed a first sheared material (solid residue 1),

(15) cooling said first sheared material to about room temperature and centrifuging (e.g., at about 14,000×g for about 10 minutes) to separate solid residue 1,

(16) suspending said solid residue 1 in boiling water and stirring (e.g., for about 5 minutes),

(17) shearing (e.g., at about 10,000 rpm for about 5 minutes) said solid residue 1 to form a second sheared material,

(18) centrifuging (e.g., at about 14,000×g for about 10 minutes) said second sheared material to separate solid residue 2,

(19) suspending said solid residue 2 in boiling water and stirring (e.g., for about 5 minutes),

(20) shearing (e.g., at about 20,000 rpm for about 5 minutes) said solid residue 2 to form a third sheared material,

(21) centrifuging (e.g., at about 14,000×g for about 10 minutes) said third sheared material to separate solid residue 3,

(22) suspending said solid residue 3 in boiling water and stirring (e.g., for about 5 minutes),

(23) shearing (e.g., at about 20,000 rpm for about 1 minute) said solid residue 3 to form a fourth sheared material,

(24) cooling said fourth sheared material to about room temperature and centrifuging (e.g., at about 14,000×g for about 10 minutes) to separate and isolate solid residue 4 which contains cellulosic fraction F4.

Cellulosic fraction F4, said cellulosic fraction F4 produced by the above process.

A process for making a hot water extract, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and or centrifugation) a hot water extracted biomass and a liquid filtrate from said de-oiled biomass, and

(3) removing water from said liquid filtrate to form said hot water extract.

A hot water extract, said hot water extract made by the above process.

A process for making materials having a molecular weight less than 30 KDa (via process that makes pectin F1), said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and or centrifugation) a hot water extracted biomass from said de-oiled biomass,

(3) removing water from said hot water extracted biomass to form a dry product (both low and high MW carbohydrates),

(4) adding water to said dry product to form a suspension and adjusting the pH of said suspension to about 1.6 (e.g., using acid like HCl),

(5) heating said suspension (e.g., at about 70° to about 100° C.; about 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) combining said washings and said acid extracted filtrate to form combined filtrate and washings and adjusting the pH of said combined filtrate and washings to about 3 to about 3.2 (e.g., with base like NaOH), and

(9) adding alcohol (e.g., ethanol, isopropanol) to said combined filtrate and washings to precipitate said pectin F1,

(10) isolating said pectin F1 (e.g., by filtration) to form isolated pectin F1 and a final filtrate, and

(11) evaporating said final filtrate to from materials having a molecular weight less than 30 KDa.

Materials having a molecular weight less than 30 KDa, said materials made by the above process.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows a basic scheme for isolating the constituents of orange peel, apple fiber, and sugar beet pulp as described below.

FIG. 2 shows a generic scheme for processing the alkali insoluble residue from FIG. 1 to produce pure cellulosic fraction F4.

FIG. 3 shows flow behavior of pectin fraction F1 from different sources as described below.

FIG. 4 shows flow behavior of pectin fraction F3 from different sources as described below.

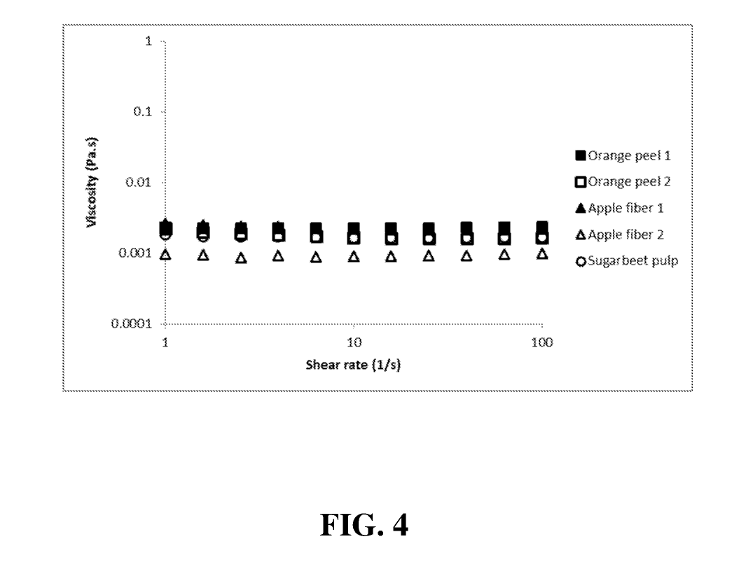

### DETAILED DESCRIPTION OF THE INVENTION

In this study we sequentially extracted citrus peel, sugar beet pulp and apple pomace using hot water, acid and an alkaline deconstruction process to produce pectin fractions 1, 2 and 3, cellulosic fraction 4, acid and alkali soluble materials, hot water extracts, and materials having a molecular weight less than 30 KDa. We compared their carbohydrate composition, molecular characteristics, proximate composition, dietary fiber composition and also studied their oil-in-water emulsification and water-holding capacity.

We have developed processes with minimum processing to prepare highly functional fiber products from sources such as sugar beet pulp, orange peel, apple pulp, and other pectin containing agricultural processing by-products and their applications.

A process for making pectin F1, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (both low and high MW carbohydrates),

(4) adding water to said dry product to form a suspension and adjusting the pH of said suspension to about 1.6 (e.g., using acid like HCl),

(5) heating said suspension (e.g., at about 70° to about 100° C.; about 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) combining said washings and said acid extracted filtrate to form combined filtrate and washings and adjusting the pH of said combined filtrate and washings to about 3 to about 3.2 (e.g., with base like NaOH), and

(9) adding alcohol (e.g., ethanol, isopropanol) to said combined filtrate and washings to precipitate said pectin F1, and

(10) isolating said pectin F1 (e.g., by filtration).

Pectin F1, said pectin F1 produced by the above process.

A process for making pectin F2, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., 70° to 100° C.; 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3, and

(13) adjusting the pH of said alkali solubilized fraction to about 4 (precipitates F2) to form pectin F2, and

(14) isolating (e.g., centrifuging and/or filtering; supernatant or filtrate contains F3) from the supernatant or filtrate obtained from pectin F2 collection

Pectin F2, said pectin F2 produced by the above process.

A process for making pectin F3, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., about 70 to about 100° C.; about 90° C.) with stirring (e.g., for about 1 to about 5 hours, about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifuging at about 14,000×g for about 10 minutes) said slurry into an alkali insoluble solid residue (used to isolate F4) and an alkali solubilized fraction which contains pectin F2 and pectin F3, and

(13) adjusting the pH of said alkali solubilized fraction to about 4 which precipitates pectin F2, and

(14) isolating (e.g., centrifuging and/or filtering; supernatant or filtrate contains F3) pectin F3 from the supernatant or filtrate obtained from pectin F2 collection.

Pectin F3, said pectin F3 produced by the above process.

A process for making acid and alkali soluble (low molecular weighty materials (via process that makes Pectin F3), said process comprising:

(1) removing oil from an agricultural by-product (e.g., orange peel; milled) to form a de-oiled biomass,

(2) adding hot water (e.g., about 75° to about 100° C.; about 90° C.; about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., at about 70 to 100° C.; about 90° C.) with stirring (e.g., for about 1 to about 5 hours; 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3,

(13) adjusting the pH of said alkali solubilized fraction to about 4 (which precipitates pectin F2),

(14) centrifuging or filtering said alkali solubilized fraction to separate and isolate pectin F2 from the supernatant or filtrate containing pectin F3,

(15) adding alcohol (e.g., ethanol, isopropanol) to said supernatant or filtrate to form a first precipitate (F3) and first decantant,

(16) removing said first precipitate and adding alcohol (e.g., ethanol, isopropanol) to form a second precipitate (F3) and second decantant, and

(17) combining said first decantant and said second decantant which contains said acid and alkali soluble materials.

Acid and alkali soluble (low molecular weight) materials, said acid and alkali soluble low molecular weight materials produced by the above process.

A process for making cellulosic fraction F4, said process comprising:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., at about 70 to about 100° C.; about 90° C.) with stirring (e.g., for about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3,

(13) suspending said alkali insoluble solid residue in boiling water and stirring (e.g., for about 5 minutes),

(14) shearing (e.g., at about 10,000 rpm for about 5 minutes) said alkali insoluble solid residue to formed a first sheared material (solid residue 1),

(15) cooling said first sheared material to about room temperature and centrifuging (e.g., at about 14,000×g for about 10 minutes) to separate solid residue 1,

(16) suspending said solid residue 1 in boiling water and stirring (e.g., for about 5 minutes),

(17) shearing (e.g., at about 10,000 rpm for about 5 minutes) said solid residue 1 to form a second sheared material,

(18) centrifuging (e.g., at about 14,000×g for about 10 minutes) said second sheared material to separate solid residue 2,

(19) suspending said solid residue 2 in boiling water and stirring (e.g., for about 5 minutes),

(20) shearing (e.g., at about 20,000 rpm for about 5 minutes) said solid residue 2 to form a third sheared material,

(21) centrifuging (e.g., at about 14,000×g for about 10 minutes) said third sheared material to separate solid residue 3,

(22) suspending said solid residue 3 in boiling water and stirring (e.g., for about 5 minutes),

(23) shearing (e.g., at about 20,000 rpm for about 1 minute) said solid residue 3 to form a fourth sheared material,

(24) cooling said fourth sheared material to about room temperature and centrifuging (e.g., at about 14,000×g for about 10 minutes) to separate and isolate solid residue 4 which contains cellulosic fraction F4.

Cellulosic fraction F4, said cellulosic fraction F4 produced by the above process.

A process for making a hot water extract, said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and or centrifugation) a hot water extracted biomass and a liquid filtrate from said de-oiled biomass, and

(3) removing water from said liquid filtrate to form said hot water extract.

A hot water extract, said hot water extract made by the above process.

A process for making materials having a molecular weight less than 30 KDa (via process that makes pectin F1), said process involving:

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and or centrifugation) a hot water extracted biomass from said de-oiled biomass,

(3) removing water from said hot water extracted biomass to form a dry product (both low and high MW carbohydrates),

(4) adding water to said dry product to form a suspension and adjusting the pH of said suspension to about 1.6 (e.g., using acid like HCl),

(5) heating said suspension (e.g., at about 70° to about 100° C.; about 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) combining said washings and said acid extracted filtrate to form combined filtrate and washings and adjusting the pH of said combined filtrate and washings to about 3 to about 3.2 (e.g., with base like NaOH), and

(9) adding alcohol (e.g., ethanol, isopropanol) to said combined filtrate and washings to precipitate said pectin F1,

(10) isolating said pectin F1 (e.g., by filtration) to form isolated pectin F1 and a final filtrate, and

(11) evaporating said final filtrate to from materials having a molecular weight less than 30 KDa.

Materials having a molecular weight less than 30 KDa, said materials made by the above process.

The amounts and ranges disclosed herein are not meant to be limiting, and increments between the recited percentages and ranges are specifically envisioned as part of the invention.

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Materials: Orange peels 1 and 2 of Valencia variety were obtained from PepsiCo Inc. and USDA Horticultural Research Laboratory, Ft. Pierce, Fla., respectively. The Valencia orange peel 1 was the leftover residue after its oil extraction by Brown Oil Extractor (BOE) procedure (Waters, R., Cold-pressed citrus oil recovery, Trans. Citrus Eng. Conf., 39: 28-48 (1993)). The residue was oven dried and ground to a 20 mesh particle size using a Wiley mill. The fresh frozen Valencia orange peel 2 was dried in an oven, ground to a 20-mesh particle size using a Wiley mill, and extracted with hexane to remove oil (Moreau, R. A., et al., J. Agric. Food Chem., 44: 2149-2154 (1996)). Apple fibers with 40 and 60 mesh particle size were obtained from FruitSmart, Inc. (WA) and Marshall Ingredients (NY) respectively. Sugar beet pulp was a gift from British Sugar, UK; it was also oven dried, ground to 20 mesh particle size, and extracted with hexane as above. Termamyl α-amylase was a gift from Novozymes, Davis, Calif. Medium Chain Triglyceride (MCT) oil (triglycerides whose fatty acids have an aliphatic tail of 6-12 carbon atoms) was purchased from Nestle Nutrition, Minneapolis, Minn. Like all triglycerides, MCT is composed of a glycerol backbone and three fatty acids in which 2 or 3 of the fatty acid chains attached to glycerol are medium-chain (6-12 carbons) in length.

Isolation of constituents from orange peels, apple fibers and sugar beet pulp: The de-oiled orange peels, apple fibers, and sugar beet pulp were extracted with hot water (75° to 100° C.) to isolate easily recoverable water soluble materials, and water was extracted leaving a hot water extracted biomass residue. The water extract was concentrated and lyophilized to obtain a dry product containing water soluble carbohydrate and non-carbohydrate materials such as soluble monosaccharaides, disaccharides, oligosaccharides, polysaccharides, protein, peptides, amino acids, fat, etc. The residue (hot water extracted biomass) left over after water extraction was suspended in 1 L water to isolate pectin by using the modified procedure of Mesbahi et al., (Mesbahi, G., et al., Food Hydrocolloids, 19:731-738 (2005)), and the pH of the suspension was adjusted to 1.6 by using conc. HCl and heated at 90° C. for 3 hours with stirring. The reaction mixture (suspension) was then cooled to room temperature and filtered (using a glass fiber filter paper) to form an acid extracted filtrate and an acid extracted residue. The residue obtained after filtration was washed with water (2×, 100 mL each) to form washings and a washed residue, and the acid extracted filtrate and two washings were combined and its pH was adjusted to 3-3.2 by using NaOH. To the combined filtrate and washings, 2× ethanol (2× to the volume of the combined solution) was added (to precipitate pectin fraction 1 (F1)) and was stored in the cold room for a few hours to complete precipitation. The precipitated acid soluble pectin fraction 1 (F1) was collected by filtration, rinsed with iso-propanol and lyophilized to dryness in a tray dryer. The filtrate was evaporated (e.g., on a rotary evaporator) and weighed to get the amount of acid soluble carbohydrates ranging from monosaccharides to oligosaccharides, usually having molecular weights below 30 KDa.

The acid insoluble washed residue obtained after pectin F1 isolation was rinsed with an alcohol (e.g., ethanol) and dried first in the chemical hood and then in a vacuum oven (e.g., at about 50° C.) to form a rinsed residue. This dry rinsed residue was used for its deconstruction by hot alkali for isolating alkali soluble pectin fractions 2 and 3 (F2 and F3) and also for making fiber gel from the alkali insoluble rinsed residue. 200 g of the dried residue was added to mechanically stirred 1150 mL hot water (about 85° C.) in a 4 L beaker to form a suspension, and the pH of suspended residue was adjusted to about 6.8 by adding 50% sodium hydroxide solution, and 2 g of α-amylase (Novozyles, Inc., Davis, Calif.) was added and stirred (e.g., for about 1 hour) to hydrolysis starch. The pH of the slurry was raised to about 11.5 by adding 31.4 mL of 50% sodium hydroxide and stirred using a mechanical stirrer at about 85° C. for about 30 minutes to completely deconstruct the material. During the reaction, its pH was kept at about 11.5 by adding more 50% NaOH, and the reaction volume was maintained the same by adding water as needed to compensate water loss due to evaporation. The slurry of the deconstructed material was transferred into a 4 L plastic beaker and immediately sheared, while it was still hot, using a high speed Polytron® (PT 10/35 GT) equipped with 12 mm probe (Brinkman Instruments) at about 10,000 rpm for about 1 hour to form the insoluble solid residue and the solubilized fraction which were separated from the reaction mixture (e.g., by centrifugation at about 14,000×g for about 10 minutes). The pH of the solubilized fraction was adjusted to about 4 (using, for example, 6M hydrochloric acid) at which time one acid insoluble fraction of pectin (called pectin fraction F2) precipitated from the solution. That precipitated pectin F2 (alkali soluble but acid insoluble) was collected (e.g., by centrifugation) and lyophilized to dryness in tray dryer.

The supernatant (containing both acid and alkali soluble pectin fractions) was taken and precipitated with two times alcohol (e.g., 100% ethanol). The precipitate was allowed to settle out as flocculent precipitate at the bottom of the beaker for about 10 to about 15 minutes. The clear alcohol/water mixture above the precipitate was removed by decantation. To make it completely water free by washing with alcohol (e.g., ethanol), the flocculent precipitate was transferred into another beaker, stirred in alcohol (e.g., 100% ethanol), filtered under vacuum and collected. The collected precipitate was suspended in water in a lyophilizing flask, frozen on dry ice and dried in a vacuum tray drier. This alcohol (e.g., ethanol) precipitated product is called pectin fraction F3. The decantant and alcohol (e.g., ethanol) wash of pectin F3 precipitate were combined and evaporated to dryness to obtain all acid and alkali soluble low molecular weight materials (e.g., soluble carbohydrates ranging from monosaccharaides to oligosaccharides, and flavanone glycosides usually having molecular weight below 30 KDa).

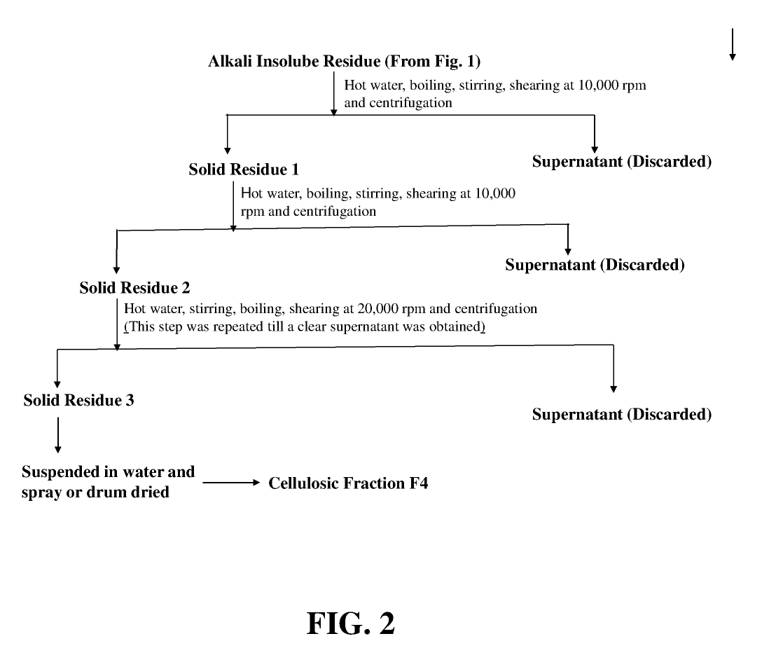

The alkali insoluble solid residue (obtained after deconstruction process above) was suspended in 2 L boiling water and stirred using a mechanical stirrer for about 5 minutes (FIG. 2). The hot suspension was transferred into a 4 L plastic beaker and sheared (e.g., at about 10,000 rpm for about 5 minutes). The sheared material was allowed to cool at room temperature and centrifuged (e.g., at about 14,000×g for about 10 minutes) to separate solid residue 1. The separated solid residue 1 was further suspended into 2 L boiling water in a 4 L glass beaker and boiled for about 5 minutes with stirring using a mechanical stirrer. The hot suspension was again transferred into 4 L plastic beaker, sheared (e.g., at 10,000 rpm for about 5 minutes) and centrifuged (e.g., at 14,000×g for about 10 minutes) to collect the solid residue 2. The solid residue 2 was suspended into boiling water, boiled for about 5 minutes with mechanical stirring, transferred into a plastic beaker and sheared (e.g., at about 20,000 rpm for about 5 minutes). Additional 2 L boiled water was added to this processed material and it was sheared again (e.g., at about 20,000 rpm for about 1 minute), and the residue (the solid residue 3) was separated by centrifugation (e.g., at about 14,000×g for about 10 minutes) after cooling the hot sheared material to room temperature. The suspension of this solid material (mentioned solid residue 1, 2 and 3 in the above shearing and washing processes of the same material) in hot water and its heating and shearing as above were repeated until a clear supernatant was seen. The final solid residue, after going through above mentioned shearing and washing steps, was collected, suspended into water to make a slurry, and dried by drum or spray drying. This final product, shown in FIG. 2, is called cellulosic fraction (F4).

Standard proximate analyses: Moisture, protein (N×6.25), and ash contents of all samples were determined using “AACC Approved Methods” 44-19, 46-30 and 08-01 respectively (AACC International 1995). Insoluble dietary fiber (IDF), soluble dietary fiber (SDF), and total dietary fiber (TDF) were determined following the standard Ankom A2000 automated fiber analyzer (ANKOM Technology, 2011).

Determination of sugar composition and linkage: Composition of the sugars of all fractions except cellulosic fraction was analyzed by HPAEC-PAD (High-Performance Anion-Exchange Chromatography) coupled with Pulsed Electrochemical Detection) after hydrolyzing the samples into monosaccharides by methanolysis combined with TFA (trifluoroacetic acid) treatment (Yadav et al., 2007b) with some modification. In brief, the samples to be analysed were first dissolved in de-ionized water (1 mg/ml). An aliquot of 100 nmoles myo-inositol (internal standard) was added to the gum solution and dried in a Teflon-lined screw cap glass vial by blowing with filtered nitrogen followed by drying in a vacuum oven at 50° C. overnight. These samples were methanolyzed with 1.5 M methanolic HCl in the presence of 20% (v/v) methyl acetate for 16 h, cooled to room temperature, and dried by blowing with filtered N2 after adding five drops of t-butanol. The methanolyzed samples were hydrolysed with 0.5 ml 2M TFA at 121° C. for 1 h, evaporated by blowing with filtered N2 at 50° C., and the residue was washed by sequential addition and evaporation of three aliquots (0.5 ml) of methanol. In four separate glass vials were placed 100, 300, 500 and 1000 nmoles of a mixture of standard sugars containing fucose, arabinose, rhamnose, galactose, glucose, xylose, glucuronic acid, and galacturonic acid. Then 100 nmoles of myo-inositol (internal standard) was added to each vial, evaporated, and dried as above. These standard samples were also methanolyzed and hydrolysed as described above and used for quantification.

Hydrolysates were analysed for neutral and acidic sugars by HPAEC-PAD using a Dionex™ DX-500 system that included a CarboPac™ PA20 column and guard column, a GP 50 gradient pump, an ED40 electrochemical detector utilizing the quadruple potential waveform (gold working electrode and pH reference electrode), an AS3500 autosampler with a thermal compartment (30° C. column-heater), and a PC10 pneumatic controller post column addition system. The mobile phase consisted of isocratic 12 mM NaOH eluant for 10 min followed by 100 mM NaOH and 6 mM CH₃COONa for 3 min, 100 mM NaOH and 12 mM CH₃COONa for 17 minutes at a flow rate of 0.5 mL/min. at ambient temperature. The column was washed with 1 M CH₃COONa for 0.10 min and 100 mM NaOH for 10 min followed by 30-min equilibration with 12 mM NaOH at a flow rate of 0.5 mL/min at ambient temperature in order to yield highly reproducible retention times for the monosaccharides. The total run time was ca. 70 min. In order to minimize baseline distortion due to change in pH of the eluant during monosaccharides detection by PAD, 730 mM NaOH was added to the postcolumn effluent via a mixing tee.

The sugar composition of cellulosic fraction (F4), isolated from orange peels, apple fibers and sugar beet pulp, was determined by using sulfuric acid for hydrolysis. Cellulosic fraction F4 (1 mg or 2 mg) was wetted with 75% of 72% (w/w) H₂SO₄ and left at room temperature for 3 h. The slurry was diluted to 1 ml to a final H₂SO₄ concentration of 2M and heated in a sealed tube for 4 h at 100° C. The tube was cooled on ice and the hydrolysate was diluted to 9 ml with MiliQ water. Sulfate ions were precipitated by drop-wise addition of saturated Ba(OH)₂ until the pH reached between 5 and 7 (checked with pH paper). The total volume of the hydrolysate was adjusted to 25 mL by adding MiliQ water and then the BaSO₄ precipitate was pelleted by centrifugation (using a table top centrifuge) at 3800 g for 5 min. The supernatant was removed very carefully to avoid picking up any precipitate and left at 4° C. overnight to allow precipitation of the remaining sulfate ions which were removed by a second centrifugation as above. The supernatant was used for analyzing monosaccharide analysis using HPAEC-PAD as given below. A mixture of standard neutral and amino sugars of known concentrations was hydrolyzed as mentioned above for cellulosic fraction at the same time. Four concentrations of standard mixtures (neutral and amino sugars) were prepared to establish a calibration equation. The concentration of each monosaccharide in the sample was quantified by linear interpolation of residue area units into the calibration equation. The monosaccharides were analyzed by HPAEC using a Dionex ICS3000 system equipped with a gradient pump, an electrochemical detector, and an autosampler. The individual neutral and amino sugars were separated by a Dionex™ CarboPac™ PA20 (3×150 mm) analytical column with an amino trap. The gradient program used the following mobile phase eluents: for neutral and amino sugars, degassed nanopure water and 200 mM NaOH. Injection was made every 43 min for neutral and amino sugars. The method mentioned above was based on the protocols described by Hardy and Townsend (Hardy, M. R., and R. R. Townsend, Methods Enzymol., 230: 208-225 (1994)).

The sugar linkage composition of cellulosic fraction (F4) was determined by gas chromatography-mass spectrometry (GC-MS) method. For this analysis, the sample was permethylated, depolymerized, reduced, and acetylated. The resulting partially methylated alditol acetate (PMAAs) was analyzed by GC-MS as described by York et al. (Methods Enzymol., 118: 3-40 (1986)).

Molecular Characterization of Pectin F1 and F3 by high-performance size-exclusion chromatography: Dried pectin samples (2 mg/mL) were dissolved in mobile phase (0.05 M NaNO₃ and 0.01% NaN₃) and filtered through a 0.45 μm Millex® HV filter (Millipore Corp., Bedford, Mass.). The flow rate for the solvent delivery system, model 1200 series degasser, auto sampler and pump, and UV-1260 Infinity (Agilent Technologies) detector was 0.7 mL/min. The injection volume was 200 μL. Samples were run in triplicate. The column set consisted of two guard columns (6.0 mm×4.0 cm, 12 μm particle size) with one placed before and one after the column set consisting of three model TSK GMPWx1 size exclusion columns (7.8 mm×300 mm, 13 μm particle size)(Tosoh Bioscience, Tokyo, Japan) in series. The columns were in a heated water bath set at 35° C. The chromatograph included a HELEOS II multi-angle laser light scattering photometer (MALLS) (Wyatt Technology, Santa Barbara, Calif.) with measurement of quasi elastic scattering (QELS) capability at 120°, model 255-V2 differential pressure viscometer (dPV), and a differential refractive index (dRI)detector (Wyatt Technology, Santa Barbara, Calif.). The electronic outputs from all the scattering angles measured by the MALLS, dPV and dRI were sent to a directory for processing with ASTRA V 6.1.1.17 software (Wyatt Technology, Santa Barbara, Calif.).

Emulsion preparation and particle size determination: The sample for emulsification (2.5 g) was prepared with 1:4 ratio of emulsifier to MCT (octanoic/decanoic acids triglycerides) containing 0.1% sodium benzoate and 0.3% citric acid (Yadav et al., 2016; Kokubun, S., et al., Food Hydrocolloids, 41:164-168 (2014)). A stock solution of emulsifier (27.78 mg/g solution) containing 0.1% (w/w) sodium benzoate (a preservative) and 0.3% (w/w) citric acid was prepared for emulsification study by slowly adding the calculated amount of pectin fraction F1 or F3 or any other test sample a little at a time with vigorous stirring to a solution of sodium benzoate and citric acid in water at room temperature, and then gently stirring overnight to produce a hydrated, well dissolved and homogeneous solution. The samples for oil-in-water emulsions were prepared in triplicate for each sample by taking 2.25 g of the above emulsifier stock solution and 0.25 g of Medium chain triglycerides (MCT, octanoic/decanoic acids triglycerides) in a glass vial. Medium chain triglycerides (density: 0.95 g/ml at 20° C.) were used as the dispersed phase since they are stable to oxidation with no bad smell or aroma and dissolve many lipophilic substances. No weighting agent was added during emulsion preparation to avoid the effects of such agent on the emulsification process. The solution was vortexed and then homogenized using a Polytron® bench top homogenizer equipped with a 12 mm diameter head (Brinkmann, Switzerland, PT 10/35) at 20,000 rpm for 3 min. The above homogenized emulsion was passed through the EmulsiFlex-B3 high-pressure homogenizer (Avestin Inc., Canada) at 20,000 psi homogenization pressure 3 times to prepare the final emulsions. The particle size distribution of the emulsions was measured by a laser diffraction particle size analyzer (Horiba LA-950) using values 1.45 and 0.001 for MCT refractive index and absorption index respectively. The volume mean diameter was used for describing particle size of emulsions. The emulsification effectiveness was evaluated on the initial particle size of the emulsion at 0 time. The emulsion stability was determined after storing emulsions at 60° C. (acceleration test) (Al-Assaf, S., et al., Food Hydrocolloids, 21: 319-328 (2007); Cirre, J., et al., Food Hydrocolloids, 35:122-128 (2014)) for 2 and 7 days.

Determination of Water holding capacity: The water holding capacity of cellulosic fraction F4 was determined according to AACC method 88-04 (AACC, 1995) with some modification. Briefly, 0.5 g of cellulosic fraction F4 sample was weighed in a polypropylene centrifuge tube with screw cap. To each tube, 24.5 mL distilled water were added and the sample was sheared using a high speed Polytron® at 10,000 rpm for 2 minutes and at 15,000 rpm for 1 minute. The tubes were placed on a shaker at room temperature and shaken at a moderate speed for about 24 hours. Then they were centrifuged at 1,500 g for 15 minutes, excess water decanted, and the tubes were inverted to completely decant any residual water. Each tube was weighed. The amount of water held was calculated by subtracting the weight before water treatment and reported as gram of water adsorbed per gram of sample.

Determination of uronic acid content and degree of esterification and acetylation: The uronic acid content (UA), degree of methyl esterification (DE), and degree of acetylation (DA) were determined by colorimetric assay and HPLC as reported previously (Fishman, M. L., et al., J. Ag. and Food Chemistry, 56: 1471-1478 (2008)).

Measurement of rheological properties: The viscosity of soluble pectin fractions F1 and F3 isolated from orange peels, apple fibers, and sugar beet pulp was measured at a concentration of 2% in pure water. For cellulosic fraction F4, samples were prepared by preparing 4% suspensions of the fraction in water followed by shearing using a high speed Polytron® at 10,000 rpm for 3 minutes and 15,000 rpm for 2 minutes. All samples were then evaluated using a rotational rheometer (Anton Paar MCR 102, Anton Paar GmBH, Graz, Austria) using concentric cylinders geometry. Shear rate was varied from 0.1 to 100 s⁻¹ for cellulosic fractions F4 and from 1 to 100 s⁻¹ for pectin fractions F1 and F3.

Results and discussion. Compositional analysis of orange peels, apple fibers, and sugar beet pulp: The compositional analysis of dried and ground orange peels, apple fibers, and sugar beet pulp are given in Table I. These by-products contained about 2 to 13% moisture and 2 to 10% ash (dry weight basis). They all were rich in protein (about 10 to 12%) and contained more IDF (33.9 to 56.7%) than SDF (11.8 to 21.8%). The total dietary fiber in these samples varied from 48.0 to 76.8%.

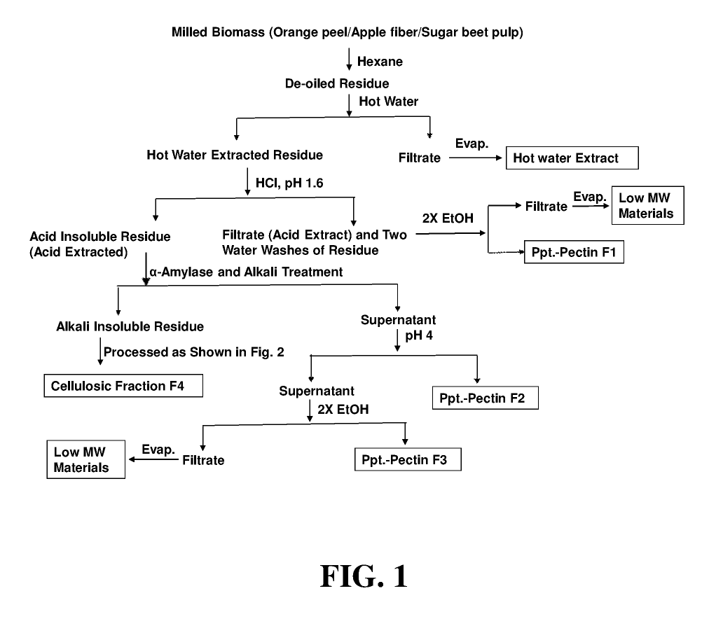

Constituents of orange peels, apple fibers, and sugar beet pulp: The different constituents present in orange peels, apple fibers, and sugar beet peel, isolated following the scheme shown in FIG. 1 are given in Table 2.

Hot water extract: The orange peel of Valencia variety 1 (obtained from PepsiCo Inc.) was processed by the supplier to extract commercial oil. This peel had a high percent (22.36%) of hot water extractable material. The orange peel of Valencia variety 2 (obtained from USDA Horticultural Research Laboratory, Ft. Pierce, Fla.) was simply dried and extracted with hexane to remove fats and oil. The peel from this variety contained a low percent (11.31%) of hot water extractable material. Apple fibers 1 and 2 contained only 9.87% and 9.36% respectively of hot water extractable material, which was relatively lower than both orange peels and sugar beet pulp (18.65%) sources.

Acid soluble pectin F1: The orange peel obtained from Valencia variety 2 contained the highest percent (18.84%) of acid soluble pectin F1. The amount of acid soluble pectin in processed orange peel (Valencia variety 1) was the lowest (11.70%). Apple fibers 1 and 2 contained 14.00% and 15.00% acid soluble pectin respectively. Sugar beet pulp was also rich in acid soluble pectin F1 (18.65%). The filtrates obtained during the collection of acid soluble pectin precipitates from orange peels and apple fibers were evaporated. They contained about 11 to 27% low molecular weight acid soluble materials, which also included salt and some other low molecular weight impurities (e.g., soluble carbohydrates ranging from monosaccharaides to oligosaccharides, usually having molecular weight below 30 KDa).

Alkali soluble pectin F2 and F3: The Valencia orange peel 2 and both apple fibers 1 and 2 contained higher amounts of pectin F2 (7.43, 11.20 and 9.00% respectively) than Valencia orange peel 1 and sugar beet pulp (2.96 and 4.09% respectively). However, the amount of pectin F3 was in the reverse order in all of these by-products. The Valencia orange peel 2 and apple fibers 1 and 2 contained only 4.12, 3.60 and 4.36% pectin F3 respectively, which was comparatively lower than pectin F3 present in Valencia orange peel 1 and sugar beet pulp (10.16 and 13.14% respectively). The filtrates obtained during the collection of pectin F3 precipitates from orange peels and apple fibers were evaporated. They contained about 11 to 15% low molecular weight alkali soluble materials, which also included salt and some other small molecular weight impurities such asorganic and inorganic acids and their salts, soluble amino acids, peptides, fats, flavanone glycosides, etc.

Insoluble cellulosic fraction F4: Valencia orange peel 1 and 2 had comparatively lower cellulosic fraction F4 (8.00 and 12.47% respectively) than the other three sources. The two apple fibers 1 and 2 had 13.60 and 16.64% cellulosic fraction F4 respectively. The sugar beet pulp contained the highest amount of cellulosic fraction F4 and so it might be the preferred source for making an insoluble fiber gel.

Sugar composition of the constituents isolated from orange peels, apple fibers, and sugar beet pulp: Table 3 and Table 4 show the sugar composition (relative mole percent) of the constituents isolated from orange, apple, and sugar beet by-products. The hot water soluble fraction of all by-products (orange peels, apple fibers, and sugar beet pulp) contained the highest molar ratio of glucose, which can be present in the form of free glucose, sucrose, and some water soluble starch and β-1,3-1,4-glucan. It contained a high percent of Ara and Xyl with some GalA, showing that this fraction may have some hot water-soluble free arabinoxylan and galacturonan. It also contained some Gal, a very low percent of GlcA, and a trace amount of Rha in the extract from some sources. The acid soluble pectin fraction (F1) from all sources contained the highest amount of GalA (˜62-81 relative mole %). It also contained some Gal, Glc, Ara and Xyl, Rha, and a trace amount of GlcA. The filtrate obtained from pectin F1 precipitate of orange peels 1 and 2 and apple fiber 2 were rich in Ara and Glc, while the filtrate from pectin F1 precipitate of apple fiber 1 had the highest GalA content, indicating that this fraction contained pectic oligosaccharides rich in arabinose. This easily extractable hot water soluble carbohydrate material can be a good source of prebiotic oligosaccharides.

The alkali soluble pectin fractions, F2 and F3, from all sources also had the highest GalA content (˜37 to 78 relative mole %), except pectin F2 from orange peel 1 whose Glc content (31.15 relative mole %) was higher than GalA (28.33 relative mole %). The neutral sugars present in F1 and F2 fractions from orange peels, apple fiber 1, and sugar beet pulp were Gal, Glc, Ara, Xyl, and Rha in varying amounts. The sugar composition of F2 and F3 fractions from apple fiber 2 were different than these fractions from the other 4 sources. These two fractions did not contain Rha. Also the total sugar content in F3 fraction from apple fiber 2 was very low, indicating a lack of high molecular weight (above 30 KDa) carbohydrate polymer in this fraction.

The major sugar present in cellulosic fraction (Table 4) from orange peels, apple fibers, and sugar beet pulp was glucose, showing a typical cellulosic backbone (rich in glucose), but they also contained quite a bit of galactose, xylose, mannose, and arabinose. This was surprising since alkali-treated, insoluble products derived from these fruit processing by-products were assumed to be purified cellulose, and should have contained primarily glucose with little to no galactose, xylose, and arabinose. Also, without being bound by theory, the rigorous purification process used for preparing the cellulosic fraction would be expected to remove all soluble sugars from the insoluble cellulosic materials. Table 4 shows, however, they surprisingly contained relative mole percent of about 71.04 to 79.94% glucose, 6.48 to 11.66% galactose, 2.08 to 16.85% xylose+mannose, and 0.00 to 12.69% arabinose with total carbohydrate content adding to 100%. The arabinose in the cellulosic fraction from orange peels and apple fibers was 0.00 to 0.69 mole %, but the one from sugar beet had 12.69 relative mole % of arabinose. Thus even with this level of extreme purification, measurable amounts of galactose and xylose+mannose were surprisingly present in cellulosic fraction from orange peels and apple fibers; similarly, measurable amounts of galactose and arabinose were present in the cellulosic fraction from sugar beet pulp. So this fraction F4 from these orange, apple, and sugar beet sources was not a pure “cellulose”. The true structure of these cellulosic fractions is not known at this time, but these materials represent novel fibrous materials not previously described.

The glycosyl linkage analysis results (Table 5) for cellulosic fraction F4 from orange peels, apple fibers, and sugar beet pulp demonstrated that they contained about 65.2 to 72.9% (1→4)-linked glucose residues, except F4 from apple fiber 1. This finding clearly showed that the major portion of this carbohydrate polymer was cellulose. It also clarified that it was not 100% cellulose, but also contained galactose, xylose, mannose, and arabinose. The most abundant terminal sugars in the F4 fraction from orange peels and apple fibers were glucose, galactose, and xylose. This fraction also contained a considerable amount of 1-4 linked xylose and mannose. The most abundant terminal sugars present in F4 fraction were arabinose, glucose, and galactose.

Emulsification study of pectin fractions F1 and F3 of orange peels, apple fibers, and sugar beet pulp: The average particle size of emulsions prepared with purified pectin fractions F1 and F3 from orange peels, apple fibers, and sugar beet pulp are shown in Table 8. The emulsification effectiveness was evaluated by first measuring the initial particle size immediately after making emulsions (0 day). Then the emulsion stability was evaluated by storing the emulsions at 60° C. (accelerated temperature stress test) and measuring the particle size after 3 and 7 days. As shown in Table 5, pectin F1 from all sources except orange peel 1 made very effective initial emulsions on 0 day with average particle size below 12 μm. Their average particle size stayed below 23 μm after 7 days storage at 60° C. The pectin fraction F3 from all sources except apple fiber 2 were good emulsifiers with the average oil droplet particle size below 9 μm at 0 day and 24 μm after 7 days storage at 60° C. Orange peel 1 was processed by the supplier before shipping, and, without being bound by theory, their processing might have removed some functional components from this pectin fraction making it an inferior emulsifier.

Water holding capacity of cellulosic residue F4 of orange peels, apple fibers, and sugar beet pulp: Table 9 shows the water holding capacity (WHC) of cellulosic residues which indicates the amount of water any dietary fiber or any food material can retain. This property varied in the fibers isolated from different sources depending upon its carbohydrate composition, branching, and molecular structure. The WHC in dietary fiber is considered to be valuable for many useful applications. The ability of fiber to hold water provides bulk and may cause a feeling of satiety without providing calories. Such a property of fiber has been proposed to be valuable in the diet to alter stool bulking and causing shorter gut transit times, thus limiting exposure of the gut to bile acids and toxins. A fiber with a high WHC makes it an ideal ingredient to add in many food products to increase their volume without changing its texture and also reducing calories per serving. As shown in Table 9, there was a remarkable variation in the WHC of cellulosic fraction F4 depending upon its source. The WHC of these fibers varied from 11.34±0.66 to a surprising 43.39±0.47 g/g (water/fiber). The WHC of cellulosic fraction F4 from orange peel 2 (43.39±0.47) and apple fiber 1 (40.05±1.01) were surprisingly higher than the cellulosic fraction F4 from orange peel 1, apple fiber 2, and sugar beet pulp (11.34±0.66, 30.78±0.89 and 23.18±1.23 respectively), suggesting some difference in their structures and branching.

The degree of methyl esterification (DE) and degree of acetylation is reported in Table 10. Pectins from all sources were low-methoxy (<50%), suggesting that they would not work well as gelling agents in sugar-acid jams or similar food applications. However, these low-methoxy pectins could gel in the presence of divalent cations such as calcium and magnesium. Only the sugar beet pectin F1 had an appreciable degree of acetylation which agrees with previously reported literature (Marry et al., J. Sci. Food Agric., 80:17-28 (2000)). Alkaline extraction of the residue remaining from acid extraction of pectin F1 completely deesterified the pectin F2 and F3 fractions from all sources (data not shown).

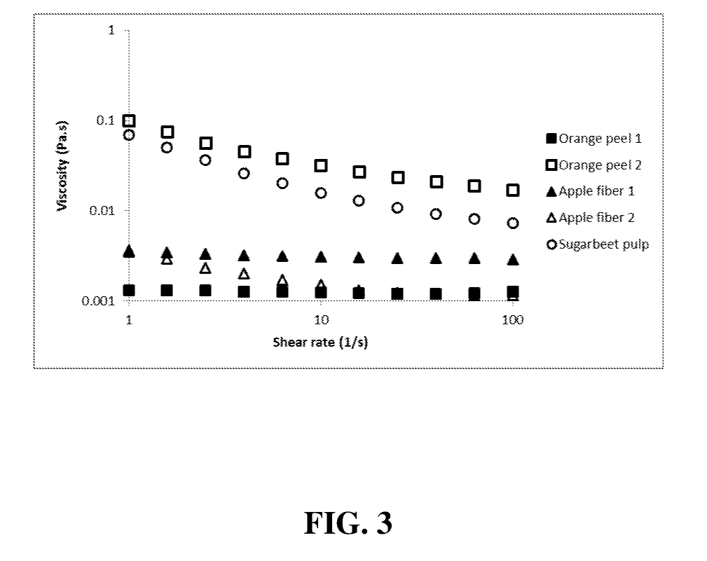

Rheological properties of pectin fractions F1 and F3 of orange peels, apple fibers, and sugar beet pulp: FIGS. 2 and 3 respectively show the flow behavior of pectin fractions F1 and F3 from different sources. In all cases the standard error bars were smaller than the point indicators and have been excluded from the figures for clarity. Most of the samples surprisingly showed Newtonian flow behavior, meaning that the viscosity did not change with shear rate. Only pectin fraction F1 from orange peel 2 and sugar beet pulp showed shear thinning behavior in which the viscosity decreased as shear rate increased. Shear thinning behavior is well-reported in the literature for pectins (Lopez da Silva, J. A., et al., Carbohydrate Polymers, 23: 77-87 (1994)), but the Newtonian behavior observed here has never been seen before. In all cases, pectin fractions F3 showed much lower viscosities than fractions F1. The reason for this is unclear but, without being bound by theory, it could be associated with lower molecular weight, higher solubility, and differences in monosaccharide composition of the fractions. Orange peel 2 pectin fraction F1 showed the highest viscosity, followed by sugar beet pulp fraction F1. Both fractions F1 and F3 from apple fiber 2 showed the lowest viscosities, as did fraction F1 from orange peel 1. The low viscosity of the soluble pectin fractions (both F1 and F3) are advantageous in terms of their use in food systems where they are not expected to negatively impact sensory characteristics. Thus, in addition to other functionalities reported herein, these fractions may be used for dietary fiber delivery in various food systems without negatively impacting palatability and consumer acceptance.

Rheological properties of cellulosic fraction F4 of orange peels, apple fibers, and sugar beet pulp: Table 11 summarizes the rheological properties of cellulosic fraction F4 from the different sources. All the samples showed shear thinning behavior, with viscosity (at shear rate of 1 s⁻¹) between 1800 to 54000 times that of water. In line with the observations on WHC, the viscosities of cellulosic fractions F4 from orange peel 2 and apple fiber 1 were surprisingly higher than those of orange peel 1, apple fiber 2, and sugar beet pulp. Even among the two high viscosity samples, fraction F4 from orange peel 2 showed much higher viscosity

(53366.7 cP) than apple fiber 1 (20966.7 cP). Thus relatively small differences in WHC (43.39 versus 40.05 for orange peel 2 and apple fiber 1 respectively) were surprisingly associated with significant differences in viscosity of the cellulosic fractions.

The Power Law model of rheological behavior was used to fit the flow behavior data. The model describes the flow behavior of the material in terms of the equations below, where σ represents the shear stress, \dot{γ} is the shear rate, η is the apparent viscosity, and k and n are parameters:

$$σ = k {\dot{γ}}^{n}$$

$$η = \frac{σ}{\dot{γ}} = \frac{k {\dot{γ}}^{n}}{\dot{γ}} = k {\dot{γ}}^{n - 1}$$

The parameters of the Power Law model, calculated by fitting the apparent viscosity versus shear rate data, are good indicators of flow behavior of the material. The parameter ‘k’, which is called the flow consistency index, is a measure of the viscosity of the material at low shear rates, while ‘n’, which is the flow behavior index, indicates how the viscosity changes as shear rate is increased. High values of k indicate that the material is thicker and more viscous at very low shear rates. Flow behavior index (n) values greater than 1 indicate that viscosity increases with shear rate, while values less than 1 indicate shear thinning behavior.

The flow behavior data for each cellulosic fraction F4 was fitted using the Power Law model, and values of flow consistency index (k) and flow behavior index (n) were calculated (Table 7). Fraction F4 from orange peel 2 showed the highest ‘k’ value, which was in line with its high apparent viscosity at 1 s⁻¹, as discussed before. Also, as expected from the apparent viscosity data, orange peel 1 fraction F4 showed the lowest flow consistency index value. For all the samples, ‘n’ values were less than 1, indicating shear-thinning behavior. The differences between actual values were illustrative of the extent of shear thinning. Orange peel 2 fraction F4 showed the lowest ‘n’ value of 0.163 (and thus the greatest decrease in viscosity with increase in shear rate), while orange peel 1 fraction F4 showed the highest ‘n’ value (0.377). This data implies that, while all the different samples were capable of providing very high viscosity at low shear rates, the viscosity surprisingly decreased significantly when the materials encountered very high shear rates, such as during pumping, which could be a valuable property during manufacturing and packaging.

Conclusions: A series of fractions with excellent oil in water emulsification and water holding capacity properties were produced by sequential extraction of pectin and cellulosic residues from agricultural by-products (e.g., orange peel, apple pomace, and sugar beet pulp). Using hot water, acid, and an alkaline deconstruction process, pectin fractions had low-methoxyl degree of esterification, low acetylation except for sugar beet pectin, low viscosity, and only the pectins from fresh frozen Valencia orange peel and sugar beet pulp had non-Newtonian shear-thinning flow properties. The alkaline extraction process solubilized the dietary fiber, decreased molecular weight, and improved the emulsification properties. These properties should improve the organoleptic properties of the dietary fiber. The cellulosic fraction produced from the fresh frozen Valencia orange peel had the best water-holding capacity. Multiple functional fractions produced from one biomass feedstock in a biorefinery will lower the cost of juice and sugar production.

All of the references cited herein, including U.S. Patents and U.S. Patent Application Publications, are incorporated by reference in their entirety. Also incorporated by reference in their entirety are the following references: Renard, C. M. G. C., J.-F. Thibault, J.-F., Lebensm.-Wisss. U.-Technol., 24: 523-527 (1991); Voragen, A. G. J., et al., Food Hydrocolloids, 1: 65-70 (1986).

Thus, in view of the above, there is described (in part) the following:

A process for making pectin F1, said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (both low and high MW carbohydrates),

(4) adding water to said dry product to form a suspension and adjusting the pH of said suspension to about 1.6 (e.g., using acid like HCl),

(5) heating said suspension (e.g., at about 70° to about 100° C.; about 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) combining said washings and said acid extracted filtrate to form combined filtrate and washings and adjusting the pH of said combined filtrate and washings to about 3 to about 3.2 (e.g., with base like NaOH), and

(9) adding alcohol (e.g., ethanol, isopropanol) to said combined filtrate and washings to precipitate said pectin F1, and

(10) isolating said pectin F1 (e.g., by filtration).

Pectin F1, said pectin F1 produced by the above process.

The pectin F1, wherein said pectin F1 has uronic acid content of about 41 to about 60 weight Percent (Wt. %). The pectin F1, wherein said pectin F1 has uronic acid content of about 46 to about 60 weight Percent (Wt. %). The pectin F1, wherein said pectin F1 has degree of esterification of about 9 to about 47. The pectin F1, wherein said pectin F1 has degree of esterification of about 14 to about 47. The pectin F1, wherein said pectin F1 has degree of acetylation of about 0.1 to about 30. The pectin F1, wherein said pectin F1 contains about 2.9 to about 6.7 relative mole % of Rha. The pectin F1, wherein said pectin F1 contains about 1.1 to about 15.8 relative mole % of Ara. The pectin F1, wherein said pectin F1 contains about 7.1 to about 14.2 relative mole % of Gal. The pectin F1, wherein said pectin F1 contains about 2.6 to about 13.3 relative mole % of Glc. The pectin F1, wherein said pectin F1 contains about 0.8 to about 5.1 relative mole % of Xyl. The pectin F1, wherein said pectin F1 contains about 61.7 to about 80.7 relative mole % of GalA. The pectin F1, wherein said pectin F1 contains about 0.3 to about 1.1 relative mole % of GlcA. The pectin F1, wherein said pectin F1 contains about 51 to about 78.1% pure BFG. The pectin F1, wherein said pectin F1 has a polydispersity of about 2.4 to about 5.1 Mw/Mn. The pectin F1, wherein said pectin F1 has a polydispersity of about 9 to about 110 Mz/Mn. The pectin F1, wherein said pectin F1 has a weight average molecular weight of about 144 to about 379×10⁻³. The pectin F1, wherein said pectin F1 has an average intrinsic viscosity of about 0.68 to about 2.7 dL/g. The pectin F1, wherein said pectin F1 has a radius of gyration of about 25 to about 29.8 nm. The pectin F1, wherein said pectin F1 has a radius of hydrodynamics of about 25.4 to about 46.1 nm. The pectin F1, wherein said pectin F1 has a Mark-Houwink exponent of about 0.36 to about 0.54.

A process for making pectin F2, said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., 70° to 100° C.; 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3, and

(13) adjusting the pH of said alkali solubilized fraction to about 4 (precipitates F2) to form pectin F2, and

(14) isolating (e.g., centrifuging and/or filtering; supernatant or filtrate contains F3) pectin F2.

Pectin F2, said pectin F2 produced by the above process.

The Pectin F2, wherein said pectin F2 contains 0 to about 23.9 relative mole % of Rha. The Pectin F2, wherein said pectin F2 contains 0 to about 9.3 relative mole % of Rha. The Pectin F2, wherein said pectin F2 contains about 0.7 to about 23.8 relative mole % of Ara. The Pectin F2, wherein said pectin F2 contains about 4.4 to about 16.9 relative mole % of Gal. The Pectin F2, wherein said pectin F2 contains about 2.4 to about 31.2 relative mole % of Glc. The Pectin F2, wherein said pectin F2 contains about 2.4 to about 18.8 relative mole % of Glc. The Pectin F2, wherein said pectin F2 contains about 1.6 to about 20.8 relative mole % of Xyl. The Pectin F2, wherein said pectin F2 contains about 28.8 to about 77.7 relative mole % of GalA. The Pectin F2, wherein said pectin F2 contains about 36.9 to about 77.7 relative mole % of GalA. The Pectin F2, wherein said pectin F2 contains about 1 to about 6.7 relative mole % of GlcA. The Pectin F2, wherein said pectin F2 contains about 74 to about 92.4% pure BFG. The Pectin F2, wherein said pectin F2 contains about 74 to about 83% pure BFG. The Pectin F2, wherein said pectin F2 has a polydispersity of about 1.4 to about 8.2 Mw/Mn. The Pectin F2, wherein said pectin F2 has a polydispersity of about 5.8 to about 130 Mz/Mn. The Pectin F2, wherein said pectin F2 has a weight average molecular weight of about 23.9 to about 272×10⁻³. The Pectin F2, wherein said pectin F2 has a weight average molecular weight of about 31.7 to about 272×10⁻³. The Pectin F2, wherein said pectin F2 has an average intrinsic viscosity of about 0.25 to about 0.41 dL/g. The Pectin F2, wherein said pectin F2 has a radius of hydrodynamics of about 8.5 to about 27.8 nm. The Pectin F2, wherein said pectin F2 has a radius of hydrodynamics of about 9.1 to about 27.8 nm. The Pectin F2, wherein said pectin F2 has a Mark-Houwink exponent of about 0.38 to about 0.88. The Pectin F2, wherein said pectin F2 has a Mark-Houwink exponent of about 0.38 to about 0.75.

A process for making pectin F3, said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., about 70 to about 100° C.; about 90° C.) with stirring (e.g., for about 1 to about 5 hours, about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifuging at about 14,000×g for about 10 minutes) said slurry into an alkali insoluble solid residue (used to isolate F4) and an alkali solubilized fraction which contains pectin F2 and pectin F3, and

(13) adjusting the pH of said alkali solubilized fraction to about 4 which precipitates pectin F2, and

(14) isolating (e.g., centrifuging and/or filtering; supernatant or filtrate contains F3) pectin F3 from the supernatant or filtrate obtained from pectin F2 collection.

Pectin F3, said pectin F3 produced by the above process.

The Pectin F3, wherein said pectin F3 contains 0 to about 12.4 relative mole % of Rha. The Pectin F3, wherein said pectin F3 contains 0 to about 3 relative mole % of Ara. The Pectin F3, wherein said pectin F3 contains about 4.3 to about 15.9 relative mole % of Gal. The Pectin F3, wherein said pectin F3 contains about 6.9 to about 15.9 relative mole % of Gal. The Pectin F3, wherein said pectin F3 contains about 2 to about 18.4 relative mole % of Glc. The Pectin F3, wherein said pectin F3 contains about 8.4 to about 18.4 relative mole % of Glc. The Pectin F3, wherein said pectin F3 contains about 10 to about 21.1 relative mole % of Xyl. The Pectin F3, wherein said pectin F3 contains about 39.1 to about 71 relative mole % of GalA. The Pectin F3, wherein said pectin F3 contains about 39.1 to about 57.2 relative mole % of GalA. The Pectin F3, wherein said pectin F3 contains 0 to about 1.5 relative mole % of GlcA.

A process for making acid and alkali soluble (low molecular weighty materials (via process that makes Pectin F3), said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.; about 1 to about 5 hours; about 3 hours) to said de-oiled biomass and separating (e.g., via filtration and/or centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., at about 70 to 100° C.; about 90° C.) with stirring (e.g., for about 1 to about 5 hours; 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3,

(13) adjusting the pH of said alkali solubilized fraction to about 4 (which precipitates pectin F2),

(14) centrifuging or filtering said alkali solubilized fraction to separate and isolate pectin F2 from the supernatant or filtrate containing pectin F3,

(15) adding alcohol (e.g., ethanol, isopropanol) to said supernatant or filtrate to form a first precipitate (F3) and first decantant,

(16) removing said first precipitate and adding alcohol (e.g., ethanol, isopropanol) to form a second precipitate (F3) and second decantant, and

(17) combining said first decantant and said second decantant which contains said acid and alkali soluble materials.

Acid and alkali soluble (low molecular weight) materials, said acid and alkali soluble low molecular weight materials produced by the above process.

A process for making cellulosic fraction F4, said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and/centrifugation) a hot water extracted biomass from said de-oiled biomass,

(3) removing water from said hot water extracted biomass to form a dry product (low MW carbohydrates),

(4) adding water to said dry product to form a suspension and adjusting the pH of said suspension to about 1.6 (e.g., using acid like HCl),

(5) heating said suspension (e.g., at about 70 to about 100° C.; about 90° C.) with stirring (e.g., for about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) rinsing said washed residue with an alcohol (e.g., ethanol, isopropanol) to form a rinsed residue (e.g., via filtration),

(9) mixing said rinsed residue with water (e.g., at about 85° C.) and adjusting the pH to about 6.8 and adding α-amylase to form a slurry (hydrolyze starch),

(10) adjusting the pH of said slurry to about 11.5 and stirring (e.g., at about 85° C. for about 30 minutes),

(11) shearing said slurry (e.g., at about 10,000 rpm for about 1 hour),

(12) separating (e.g., centrifugation at about 14,000×g for about 10 minutes) said slurry into an alkali insoluble solid residue (used to isolate F4) and an alkali solubilized fraction which contains pectin F2 and pectin F3,

(13) suspending said alkali insoluble solid residue in boiling water and stirring (e.g., for about 5 minutes),

(14) shearing (e.g., at about 10,000 rpm for about 5 minutes) said alkali insoluble solid residue to formed a first sheared material (solid residue 1),

(15) cooling said first sheared material to about room temperature and centrifuging (e.g., at about 14,000×g for about 10 minutes) to separate solid residue 1,

(16) suspending said solid residue 1 in boiling water and stirring (e.g., for about 5 minutes),

(17) shearing (e.g., at about 10,000 rpm for about 5 minutes) said solid residue 1 to form a second sheared material,

(18) centrifuging (e.g., at about 14,000×g for about 10 minutes) said second sheared material to separate solid residue 2,

(19) suspending said solid residue 2 in boiling water and stirring (e.g., for about 5 minutes),

(20) shearing (e.g., at about 20,000 rpm for about 5 minutes) said solid residue 2 to form a third sheared material,

(21) centrifuging (e.g., at about 14,000×g for about 10 minutes) said third sheared material to separate solid residue 3,

(22) suspending said solid residue 3 in boiling water and stirring (e.g., for about 5 minutes),

(23) shearing (e.g., at about 20,000 rpm for about 1 minute) said solid residue 3 to form a fourth sheared material,

(24) cooling said fourth sheared material to about room temperature and centrifuging (e.g., at about 14,000×g for about 10 minutes) to separate and isolate solid residue 4 which contains cellulosic fraction F4; or cooling said fourth sheared material to about room temperature and centrifuging (e.g., at about 14,000×g for about 10 minutes) to separate solid residue 4, repeat steps (22), (23) and (24) until a clear supernatant is produced, and collecting the final solid residue which contains cellulosic fraction F4.

Cellulosic fraction F4, said cellulosic fraction F4 produced by the above process.

The Cellulosic Fraction F4, said cellulosic fraction F4 containing about 71 to about 80 relative mole %) glucose, about 6 to about 12 relative mole % galactose, about 0.5 to about 13 relative mole % arabinose, about 2 to about 17 relative mole % xylose and mannose (wherein the total relative mole % of glucose, galactose, arabinose, xylose and mannose is 100 relative mole %). The Cellulosic Fraction F4, said cellulosic fraction F4 containing about 71 to about 75 relative mole %) glucose, about 8 to about 12 relative mole % galactose, about 0.5 to about 13 relative mole % arabinose, about 2 to about 17 relative mole % xylose and mannose (wherein the total relative mole % of glucose, galactose, arabinose, xylose and mannose is 100 relative mole %). The Cellulosic Fraction F4, said cellulosic fraction F4 having a water holding capacity from about 11 to about 44 g water held/g cellulosic fraction F4. The Cellulosic Fraction F4, said cellulosic fraction F4 having a water holding capacity from about 23 to about 44 g water held/g cellulosic fraction F4. The Cellulosic Fraction F4, said cellulosic fraction F4 having an apparent viscosity at 1 s⁻¹ of about 12,034 to about 23,521 cP. The Cellulosic Fraction F4, said cellulosic fraction F4 having a flow consistency index of about 2.4 to about 68.7 Pa·sⁿ. The Cellulosic Fraction F4, said cellulosic fraction F4 having a flow consistency index of about 18.3 to about 68.7 Pa·sⁿ. The Cellulosic Fraction F4, said cellulosic fraction F4 having a flow behavior index of about 0.16 to about 0.38. The Cellulosic Fraction F4, said cellulosic fraction F4 having a flow behavior index of about 0.16 to about 0.32.

A process for making a hot water extract, said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and or centrifugation) a hot water extracted biomass and a liquid filtrate from said de-oiled biomass, and

(3) removing water from said liquid filtrate to form said hot water extract.

A hot water extract, said hot water extract made by the above process.

A process for making materials having a molecular weight less than 30 KDa (via process that makes pectin F1), said process comprising (or consisting essentially of or consisting of):

(1) removing oil from an agricultural by-product (e.g., orange peel; milled) to form a de-oiled biomass,

(2) adding hot water (e.g., about 75° to about 100° C.; about 90° C.) with stirring (e.g., about 1 to about 5 hours; about 3 hours) to said de-oiled biomass and separating (e.g., via filtration and or centrifugation) a hot water extracted biomass from said de-oiled biomass,

(3) removing water from said hot water extracted biomass to form a dry product (both low and high MW carbohydrates),

(4) adding water to said dry product to form a suspension and adjusting the pH of said suspension to about 1.6 (e.g., using acid like HCl),

(5) heating said suspension (e.g., at about 70° to about 100° C.; about 90° C.) with stirring (e.g., about 1 to about 5 hours; about 3 hours),

(6) cooling said suspension to about room temperature and separating (e.g., filtering) said suspension to produce an acid extracted residue and an acid extracted filtrate,

(7) washing said acid extracted residue with water (e.g., 2×) to form washings and a washed residue,

(8) combining said washings and said acid extracted filtrate to form combined filtrate and washings and adjusting the pH of said combined filtrate and washings to about 3 to about 3.2 (e.g., with base like NaOH), and

(9) adding alcohol (e.g., ethanol, isopropanol) to said combined filtrate and washings to precipitate said pectin F1,

(10) isolating said pectin F1 (e.g., by filtration) to form isolated pectin F1 and a final filtrate, and

(11) evaporating said final filtrate to from materials having a molecular weight less than 30 KDa.

Materials having a molecular weight less than 30 KDa, said materials made by the above process.

The term “consisting essentially of” excludes additional method (or process) steps or composition components that substantially interfere with the intended activity of the method (or process) or composition.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Proximate composition of orange peels, apple fibers, and sugar beep
pulp (Wt. % on dry weight basis).

| Sources | Protein | Moisture | Ash | IDF | SDF | TDF |
|---|---|---|---|---|---|---|
| Valencia | 12.41 ± 1.85 | 12.91 ± 0.12 | 6.24 ± 0.03 | 37.8 | 11.8 | 49.6 |
| Orange | | | | | | |
| Peel 1 | | | | | | |
| Valencia | 12.44 ± 1.19 | 5.85 ± 0.10 | 3.80 ± 0.44 | 39.0 | 21.8 | 60.8 |
| Orange | | | | | | |
| Peel 2 | | | | | | |
| Apple | 10.45 ± 0.70 | 8.28 ± 0.22 | 1.64 ± 0.01 | 33.9 | 14.0 | 48.0 |
| Fiber 1 | | | | | | |
| Apple | 10.62 ± 0.18 | 8.94 ± 0.02 | 1.55 ± 0.01 | 43.6 | 17.1 | 60.7 |
| Fiber 2 | | | | | | |
| Sugar | 14.64 ± 4.01 | 1.70 ± 0.02 | 10.21 ± 0.39 | 56.7 | 20.1 | 76.8 |
| Beet | | | | | | |
| Pulp | | | | | | |

Valencia orange peel 1, obtained from PepsiCo Inc.;
Valencia orange peel 2, obtained from USDA Horticultural Research Laboratory, Ft. Pierce, FL;
Apple fiber 1 (40 mesh) obtained from FruitSmart, Inc. WA;
Apple fiber 2 (60 mesh) obtained from Marshall Ingredients, NY;
Sugar beet pulp obtained from British Sugar, UK.

TABLE 2
Isolated components of orange peels, apple fibers, and sugar beet pulp^{a}
(percent on dry weight basis).

| | | | Filtrate | | | Filtrate | | |
|---|---|---|---|---|---|---|---|---|
| | | | obtained | | | obtained | | |
| | | | from | | | from | | |
| | | Acid | pectin | Alkali | Alkali | pectin | | |
| | Hot | soluble | (F-1) | soluble | soluble | (F3) | Cellulosic | |
| | water | pectin, | Precipitate | pectin, | pectin, | Precipitate | Fraction, | |
| Samples | extract | F-1 | collection | F2 | F3 | collection | F4 | Total |
| Valencia | 22.36 | 11.70 | 26.67 | 2.96 | 10.16 | 11.48 | 8.00 | 93.33 |
| Orange | | | | | | | | |
| Peel 1 | | | | | | | | |
| Valencia | 11.31 | 18.84 | 27.01 | 7.43 | 4.12 | 15.04 | 12.47 | 96.22 |
| Orange | | | | | | | | |
| Peel 2 | | | | | | | | |
| Apple | 9.87 | 14.00 | 17.06 | 11.20 | 3.60 | 11.36 | 13.60 | 80.69 |
| Fiber 1 | | | | | | | | |
| Apple | 9.36 | 15.00 | 11.28 | 9.00 | 4.36 | 15.21 | 16.64 | 80.85 |
| Fiber 2 | | | | | | | | |
| Sugar | 18.65 | 10.38 | ND | 4.09 | 13.14 | ND | 40.32 | 86.58 |
| Beet Pulp | | | | | | | | |

^{a}Weight percent based on the de-oiled samples; F1, Fraction 1; F2, Fraction 2; F3, Fraction 3 and F4, cellulosic Fraction 4. Refer to table 1 for samples sources.

TABLE 3
Sugar composition of orange peels, apple fibers, and sugar beet pulp
constituents (Relative mole %).

| | | | | | | | | |
|---|---|---|---|---|---|---|---|---|
| Sample | | | | | | | | |
| Fractions | Rha | Ara | Gal | Glc | Xyl | GalA | GlcA | Total |

Valencia Orange Peel 1

| | | | | | | | | |
|---|---|---|---|---|---|---|---|---|
| Hot Water | 1.73 | 9.21 | 4.72 | 65.85 | 10.22 | 7.60 | 0.67 | 100.00 |
| Extract | | | | | | | | |
| Pectin, F1 | 5.77 | 2.43 | 14.18 | 3.08 | 0.97 | 72.62 | 0.96 | 100.00 |
| Filtrate from | 1.45 | 44.69 | 15.76 | 32.16 | 4.55 | 0.76 | 0.64 | 100.00 |
| Pectin, | | | | | | | | |
| Flprecipitate | | | | | | | | |
| Pectin, F2 | 23.91 | 1.68 | 4.37 | 31.15 | 8.15 | 28.33 | 2.41 | 100.00 |
| Pectin F3 | 7.90 | 0.66 | 4.34 | 1.98 | 13.33 | 71.01 | 0.78 | 100.00 |
| Filtrate from | 1.36 | 45.05 | 15.53 | 32.20 | 4.43 | 0.79 | 0.63 | 100.00 |
| Pectin F3 | | | | | | | | |
| precipitate | | | | | | | | |
| Cellulosic | 0.00 | 0.57 | 5.68 | 42.10 | 48.97 | 2.19 | 0.49 | 100.00 |
| Fraction, F4 | | | | | | | | |

Valencia Orange Peel 2

| | | | | | | | | |
|---|---|---|---|---|---|---|---|---|
| Hot Water | 1.47 | 12.74 | 4.13 | 64.12 | 13.78 | 3.24 | 0.52 | 100.00 |
| Extract | | | | | | | | |
| Pectin, F1 | 3.20 | 6.97 | 10.47 | 13.23 | 1.77 | 63.71 | 0.65 | 100.00 |
| Filtrate from | 1.44 | 43.23 | 4.92 | 43.13 | 5.79 | 0.84 | 0.66 | 100.00 |
| Pectin | | | | | | | | |
| F1precipitate | | | | | | | | |
| Pectin F2 | 7.01 | 0.75 | 3.95 | 8.01 | 1.59 | 77.71 | 0.99 | 100.00 |
| Pectin F3 | 10.64 | 2.58 | 15.91 | 18.43 | 10.97 | 39.96 | 1.52 | 100.00 |
| Filtrate from | 28.92 | 7.88 | 4.51 | 49.83 | 6.99 | 1.05 | 0.83 | 100.00 |
| Pectin F3 | | | | | | | | |
| precipitate | | | | | | | | |
| Cellulosic | 0.00 | 0.87 | 9.03 | 34.09 | 53.46 | 1.98 | 0.57 | 100.00 |
| Fraction, F4 | | | | | | | | |

Apple Fiber 1

| | | | | | | | | |
|---|---|---|---|---|---|---|---|---|
| Hot Water | 0.15 | 3.81 | 1.02 | 68.87 | 7.82 | 17.72 | 0.60 | 100.00 |
| Extract | | | | | | | | |
| Pectin, F1 | 2.96 | 1.13 | 7.81 | 4.05 | 2.89 | 80.64 | 0.52 | 100.00 |
| Filtrate from | 2.61 | 6.04 | 5.79 | 6.21 | 2.54 | 76.31 | 0.50 | 100.00 |
| Pectin | | | | | | | | |
| F1precipitate | | | | | | | | |
| Pectin F2 | 3.33 | 5.75 | 13.77 | 18.77 | 14.83 | 36.88 | 6.66 | 100.00 |
| Pectin F3 | 12.43 | 2.98 | 14.63 | 8.38 | 21.11 | 39.16 | 1.31 | 100.00 |
| Filtrate from | 0.83 | 3.86 | 29.09 | 20.00 | 32.51 | 10.03 | 3.69 | 100.00 |
| Pectin F3 | | | | | | | | |
| precipitate | | | | | | | | |
| Cellulosic | 0.00 | 0.36 | 10.56 | 39.28 | 47.16 | 2.15 | 0.48 | 100.00 |
| Fraction, F4 | | | | | | | | |

Apple Fiber 2

| | | | | | | | | |
|---|---|---|---|---|---|---|---|---|
| Hot Water | 0.01 | 14.23 | 1.79 | 46.96 | 3.11 | 33.59 | 0.31 | 100.00 |
| Extract | | | | | | | | |
| Pectin, F1 | 6.69 | 4.64 | 7.14 | 2.62 | 5.05 | 73.59 | 0.27 | 100.00 |
| Filtrate from | 0.07 | 56.48 | 14.60 | 21.07 | 5.22 | 2.57 | 0.00 | 100.00 |
| Pectin | | | | | | | | |
| F1precipitate | | | | | | | | |
| Pectin F2 | 0.19 | 17.71 | 9.67 | 2.54 | 20.75 | 47.96 | 1.18 | 100.00 |
| Pectin F3 | 1.22 | 0 | 6.87 | 18.06 | 17.31 | 56.54 | 0.0 | 100.00 |
| Filtrate from | 4.94 | 0 | 23.19 | 29.02 | 38.28 | 4.56 | 0.00 | 100.00 |
| Pectin F3 | | | | | | | | |
| precipitate | | | | | | | | |
| Cellulosic | 0 | 0 | 8.11 | 39.31 | 47.85 | 4.73 | 0.00 | 100.00 |
| Fraction, F4 | | | | | | | | |

Sugar Beet Pulp

| | | | | | | | | |
|---|---|---|---|---|---|---|---|---|
| Hot Water | 1.22 | 19.04 | 2.45 | 29.46 | 1.89 | 45.33 | 0.61 | 100.00 |
| Extract | | | | | | | | |
| Pectin, F1 | 5.44 | 15.75 | 9.42 | 5.82 | 0.79 | 61.69 | 1.09 | 100.00 |
| Pectin, F2 | 9.32 | 23.75 | 16.89 | 2.39 | 3.77 | 37.24 | 6.64 | 100.00 |
| Pectin, F3 | 14.90 | 10.61 | 21.63 | 1.52 | 0.90 | 47.45 | 2.97 | 100.00 |
| Cellulosic | 1.16 | 5.59 | 6.11 | 48.05 | 33.42 | 4.53 | 1.13 | 100.00 |
| Fraction, F4 | | | | | | | | |

Note:
Ara, Arabinose;
Gal, Galactose;
Glc, Glucose;
Xyl, Xylose;
GalA, Galacuronic acid;
GlcA, Glucuronic acid.

TABLE 4
Sugar composition of cellulosic fraction (F4) isolated from
orange peels, apple fibers, and sugar beet pulp

| | Sugar Content (Relative Mole %) | | | | |
|---|---|---|---|---|---|
| Cellulosic | | | | Xylose + | |
| Fraction (F4) | Glucose | Galactose | Arabinose | Mannose | Total |
| Valencia orange | 79.94 | 6.48 | 0.46 | 13.12 | 100.00 |
| peel 1 | | | | | |
| Valencia orange | 74.18 | 9.78 | 0.69 | 15.35 | 100.00 |
| peel 2 | | | | | |
| Apple fiber 1 | 72.55 | 11.66 | 0.00 | 15.79 | 100.00 |
| Apple fiber 2 | 75.04 | 8.11 | 0.00 | 16.85 | 100.00 |
| Sugar beet pulp | 71.04 | 8.72 | 12.69 | 2.08 | 100.00 |

TABLE 5
Glycosyl-linkage composition of cellulosic fraction (F4) isolated
from orange peels, apple fibers, and sugar beet pulp

| | |
|---|---|
| | Relative peak |
| Glycosyl residue linkage | area (%) |

Valencia orange peel 1

| | |
|---|---|
| Terminally linked Arabinopyranosyl residue (t-Ara) | 0.1 |
| Terminally linked Xylopyranosyl residue (t-Xyl) | 1.8 |
| Terminally linked Manopyranosyl residue (t-Man) | 0.9 |
| Terminally linked Glucopyranosyl residue (t-Glc) | 3.4 |
| Terminally linked Galactopyranosyl residue (t-Gal) | 2.2 |
| 4 linked Xylopyranosyl residue (4-Xyl) | 2.9 |
| 4 linked Manopyranosyl residue (4-Man) | 15.5 |
| 2 linked Galactopyranosyl residue (2-Gal) | 0.2 |
| 6 linked Glucopyranosyl residue (6-Glc) | 0.3 |
| 4 linked Galactopyranosyl residue (4-Gal) | 0.1 |
| 4 linked Glucopyranosyl residue (4-Glc) | 65.2 |
| 3,4 linked Glucopyranosyl residue (3,4-Glc) | 0.8 |
| 2,4 linked Manopyranosyl residue (2,4-Man) | 0.2 |
| 2,4 linked Glucopyranosyl residue (2,4-Glc) | 0.7 |
| 4,6 linked Manopyranosyl residue (4,6-Glc) | 1.5 |
| 4,6 linked Glucopyranosyl residue (4,6-Glc) | 4.2 |
| Total | 100.0 |

Valencia orange peel 2

| | |
|---|---|
| Terminally linked Arabinopyranosyl residue (t-Ara) | 0.1 |
| Terminally linked Xylopyranosyl residue (t-Xyl) | 1.1 |
| Terminally linked Manopyranosyl residue (t-Man) | 0.4 |
| Terminally linked Glucopyranosyl residue (t-Glc) | 2.4 |
| Terminally linked Galactopyranosyl residue (t-Gal) | 2.3 |
| 4 linked Xylopyranosyl residue (4-Xyl) | 4.0 |
| 4 linked Manopyranosyl residue (4-Man) | 9.4 |
| 2 linked Galactopyranosyl residue (2-Gal) | 0.4 |
| 6 linked Glucopyranosyl residue (6-Glc) | 0.2 |
| 4 linked Galactopyranosyl residue (4-Gal) | 0.2 |
| 4 linked Glucopyranosyl residue (4-Glc) | 72.9 |
| 3,4 linked Glucopyranosyl residue (3,4-Glc) | 0.7 |
| 2,4 linked Manopyranosyl residue (2,4-Man) | 0.5 |
| 4,6 linked Manopyranosyl residue (4,6-Glc) | 1.0 |
| 4,6 linked Glucopyranosyl residue (4,6-Glc) | 4.4 |
| Total | 100.0 |

Apple fiber 1

| | |
|---|---|
| Terminal Xylopyranosyl residue (t-Xyl) | 0.2 |
| Terminal Mannopyranosyl residue (t-Man) | 0.2 |
| Terminal Glucopyranosyl residue (t-Glc) | 1 |
| Terminal Galactopyranosyl residue (t-Gal) | 2.2 |
| 2-linked Xylopyranosyl residue (2-Xyl) | 0.7 |
| 4-linked Xylopyranosyl residue (4-Xyl) | 0.7 |
| 4-linked Mannopyranosyl residue (4-Man) | 4.7 |
| 2-linked Galactopyranosyl residue (2-Gal) | 0.5 |
| 6-linked Glucopyranosyl residue (6-Glc) | 0.3 |
| 4-linked Galactopyranosyl residue (4-Gal) | 0.1 |
| 4-linked Glucopyranosyl residue (4-Glc) | 79 |
| 2,4-linked Xylopyranosyl residue (2,4-Xyl) | 0.4 |
| 6-linked Galactopyranosyl residue (6-Gal) | 0.4 |
| 3,4-linked Glucopyranosyl residue (3,4-Glc) | 0.5 |
| 2,4-linked Mannopyranosyl residue (2,4-Man) | 0.4 |
| 4,6-linked Mannopyranosyl residue (4,6-Man) | 0.4 |
| 4,6-linked Glucopyranosyl residue (4,6-Glc) | 8.6 |
| Total | 100 |

Apple fiber 2

| | |
|---|---|
| Terminally linked Xylopyranosyl residue (t-Xyl) | 2.4 |
| Terminally linked Manopyranosyl residue (t-Man) | 0.3 |
| Terminally linked Glucopyranosyl residue (t-Glc) | 1.2 |
| Terminally linked Galactopyranosyl residue (t-Gal) | 1.7 |
| 3 linked Xylopyronosyl residue (3-Xyl) | 0.3 |
| 4 linked Xylopyranosyl residue (4-Xyl) | 3.9 |
| 3 linked Glucopyranosyl residue (3-Glc) | 0.2 |
| 4 linked Manopyranosyl residue (4-Man) | 6.5 |
| 2 linked Galactopyranosyl residue (2-Gal) | 0.1 |
| 6 linked Glucopyranosyl residue (6-Glc) | 0.2 |
| 4 linked Galactopyranosyl residue (4-Gal) | 0.1 |
| 4 linked Glucopyranosyl residue (4-Glc) | 69.4 |
| 3,4 linked Glucopyranosyl residue (3,4-Glc) | 1.9 |
| 2,4 linked Manopyranosyl residue (2,4-Man) | 2.1 |
| 4,6 linked Manopyranosyl residue (4,6-Glc) | 0.4 |
| 4,6 linked Glucopyranosyl residue (4,6-Glc) | 8.6 |
| 3,4,6 linked Glucopyranosyl residue (3,4,6-Glc) | 0.4 |
| 2,4,6 linked Glucopyranosyl residue (2,4,6-Glc) | 0.4 |
| Total | 100.0 |

Sugar beet pulp

| | |
|---|---|
| Terminally linked Arabinofuranosyl residue (t- | 2.5 |
| Araf) | |
| Terminally linked Arabinopyranosyl residue (t-Ara) | 0.6 |
| 2 linked Rhamnopyranosyl residue (2-Rha) | 0.4 |
| Terminally linked Manopyranosyl residue (t-Man) | 0.7 |
| Terminally linked Glucopyranosyl residue (t-Glc) | 3.5 |
| Terminally linked Galactopyranosyl residue T-Gal) | 0.8 |
| 4 linked Arabinopyranosyl residue or 5 linked | 1.5 |
| Arabinofuranosyl residue (4-Arap or 5-Araf) | |
| 4 linked Xylopyranosyl residue (4-Xyl) | 2.4 |
| 2,4 linked Rhamnopyranosyl residue (2,4-Rha) | 1.0 |
| 4 linked Manopyranosyl residue (4-Man) | 6.3 |
| 3,4 linked Arabinopyranosyl residue or 3,5 linked | 1.5 |
| Arabinofuranosyl residue (3,4-Arap or 3,5-Araf) | |
| 4 linked Galactopyranosyl residue (4-Gal) | 1.5 |
| 4 linked Glucopyranosyl residue (4-Glc) | 71.6 |
| 3,4 linked Glucopyranosyl residue (3,4-Glc) | 1.2 |
| 2,4 linked Glucopyranosyl residue (2,4-Glc) | 2.4 |
| 4,6 linked Glucopyranosyl residue (4,6-Glc) | 2.3 |
| Total | 100 |

TABLE 6
Proximate composition and dietary fiber content of orange peels, apple fibers,
and sugar beet pulp (Wt. % on dry weight basis)

| | | | | | | |
|---|---|---|---|---|---|---|
| Sample Fractions | Moisture | Ash | Protein | IDF | SDF | TDF |

Valencia Orange Peel 1

| | | | | | | |
|---|---|---|---|---|---|---|
| Hot Water Ext. | 25.89 ± 0.25 | 9.76 ± 0.84 | 14.91 ± 0.12 | 1.0 | 10.5 | 11.5 |
| Pectin, F1 | 8.95 ± 0.26 | 21.16 ± 0.07 | 9.58 ± 2.37 | 33.9 | 33.4 | 67.3 |
| Filtrate from Pectin, | 16.75 ± 0.40 | 53.24 ± 0.48 | 10.42 ± 0.42 | 2.2 | 1.4 | 3.6 |
| F1 | | | | | | |
| Pectin F2 | 8.07 0 ± 0.20 | 6.72 ± 0.39 | 53.40 ± 1.53 | 1.7 | 31.3 | 33.0 |
| Pectin F3 | 12.58 ± 0.57 | 10.48 ± 0.08 | 2.55 ± 0.11 | 0.5 | 66.4 | 66.9 |
| Filtrate from Pectin | 7.77 ± 0.25 | 59.04 ± 1.03 | 7.92 ± 2.78 | 2.6 | 2.8 | 5.4 |
| F3 | | | | | | |
| Cellulosic Fraction, | 4.47 ± 0.17 | 2.32 ± 0.29 | 7.39 ± 2.51 | 91.9 | 2.3 | 94.2 |
| F4 | | | | | | |

Valencia Orange Peel 2

| | | | | | | |
|---|---|---|---|---|---|---|
| Hot Water Ext. | 23.78 ± 0.12 | 4.62 ± 0.01 | 4.36 ± 0.11 | 0.7 | 6.5 | 7.2 |
| Pectin, F1 | 9.88 ± 0.47 | 9.42 ± 0.00 | 11.72 ± 0.63 | 23.5 | 55.2 | 78.7 |
| Filtrate from Pectin | 29.77 ± 0.20 | 18.86 ± 0.02 | 3.39 ± 0.22 | 0.5 | 3.5 | 4.0 |
| F1 | | | | | | |
| Pectin F2 | 47.31 ± 0.94 | 12.24 ± 0.05 | 6.90 ± 0.09 | 1.1 | 29.1 | 30.2 |
| Pectin F3 | 9.60 ± 0.76 | 19.06 ± 0.12 | 10.29 ± 2.01 | 0.8 | 86.5 | 87.3 |
| Filtrate from Pectin | 11.48 ± 0.02 | 40.12 ± 0.11 | 8.07 ± 0.21 | 0.6 | 2.2 | 2.8 |
| F3 | | | | | | |
| Cellulosic Fraction, | 7.02 ± 0.65 | 1.51 ± 0.29 | 0.00 ± 0.00 | 92.1 | 1.1 | 93.2 |
| F4 | | | | | | |

Apple Fiber 1

| | | | | | | |
|---|---|---|---|---|---|---|
| Hot Water Ext. | 29.78 ± 0.05 | 2.20 ± 0.10 | 5.01 ± 0.8 | 0.3 | 7.7 | 8.0 |
| Pectin, F1 | 10.63 ± 0.33 | 1.01 ± 0.27 | 0.15 ± 0.13 | 0.6 | 96.2 | 96.8 |
| Filtrate from Pectin | 15.18 ± 0.11 | 10.06 ± 0.05 | 0.00 ± 0.00 | 1.3 | 70.8 | 72.1 |
| F1 | | | | | | |
| Pectin F2 | 5.95 ± 0.56 | 12.44 ± 0.36 | 13.88 ± 0.06 | 1.1 | 37.9 | 39.0 |
| Pectin F3 | 6.29 ± 0.41 | 0.18 ± 0.00 | 1.70 ± 0.13 | 0.0 | 76.8 | 76.8 |
| Filtrate from Pectin | 7.53 ± 0.09 | 71.34 ± 0.22 | 0.00 ± 0.00 | 0.4 | 2.3 | 2.7 |
| F3 | | | | | | |
| Cellulosic Fraction, | 4.24 ± 0.20 | 0.00 | 0.00 | 92.3 | 2.3 | 94.6 |
| F4 | | | | | | |

Apple Fiber 2

| | | | | | | |
|---|---|---|---|---|---|---|
| Hot Water Ext. | 26.44 ± 0.65 | 3.06 ± 0.54 | 0.00 ± 0.00 | 0.1 | 11.8 | 11.9 |
| Pectin, F1 | 8.58 ± 0.15 | 0.14 ± 0.01 | 0.00 ± 0.00 | 7.7 | 69.3 | 77.0 |
| Filtrate from Pectin | 9.42 ± 0.14 | 65.62 ± 1.33 | 0.00 ± 0.00 | 0.5 | 1.7 | 2.2 |
| F1 | | | | | | |
| Pectin F2 | 6.99 ± 0.38 | 10.91 ± 0.00 | 12.84 ± 3.18 | 1.2 | 41.7 | 42.9 |
| Pectin F3 | 15.10 ± 0.07 | 14.08 ± 0.17 | 4.33 ± 0.22 | 0.1 | 88.2 | 88.3 |
| Filtrate from Pectin | 11.19 ± 2.84 | 79.02 ± 0.23 | 9.46 ± 1.69 | 0.0 | 11.7 | 11.7 |
| F3 | | | | | | |
| Cellulosic Fraction, | 4.35 ± 0.27 | 0.90 ± 0.26 | 0.00 ± 0.00 | 93.4 | 2.1 | 95.5 |
| F4 | | | | | | |

Sugar Beet Pulp

| | | | | | | |
|---|---|---|---|---|---|---|
| Hot Water Ext. | 11.65 ± 0.46 | 10.21 ± 0.39 | 5.45 ± 1.59 | 0.1 | 35.4 | 35.5 |
| Pectin, F1 | 6.52 ± 0.94 | 4.19 ± 0.19 | 11.46 ± 2.24 | 0.0 | 75.4 | 75.4 |
| Pectin F2 | 11.46 ± 0.46 | 12.36 ± 0.07 | 32.62 ± 2.80 | 7.6 | 41.0 | 48.6 |
| Pectin F3 | 8.30 ± 1.00 | 11.55 ± 0.01 | 2.06 ± 0.13 | 0.00 | 99.8 | 99.8 |
| Cellulosic Fraction, | 6.34 ± 0.21 | 8.17 ± 0.37 | 4.15 ± 0.05 | 61.6 | 3.7 | 65.3 |
| F4 | | | | | | |

TABLE 7
Molecular Characteristics of fractions F1 and F3 isolated from orange peels, apple fibers,
and sugar beet pulp

| | Measured by HPSEC with Multi Angle Laser Light Scattering, Viscometric, and Refractive | | | | | | | |
|---|---|---|---|---|---|---|---|---|
| | Index Detectors | | | | | | | |
| | | | | | Av. | | | |
| | | | | Wt. Av. | Intrinsic | Radius of | | |
| | % | | | Mol. Wt. | Viscosity | Gyration | Radius of | |
| | Pure | Polydispersity | Polydispersity | (Mw × | (ηw, | (Rgz, | Hydrodynamics | Mark-Houwink |
| Sample | BFG¹ | Mw/Mn | Mz/Mn | 10-3) | dL/g) | nm) | (Rhz, nm) | Exponent (a) |

Valencia Orange Peel 1

| | | | | | | | | |
|---|---|---|---|---|---|---|---|---|
| Pectin | 51.7 ± 0.4 | 4.47 ± 0.01 | 99.5 ± 8.0 | 254 ± 6 | 0.778 ± 0.06 | 29.5 ± 0.1 | 45.8 ± 3.0 | 0.539 ± 0.04 |
| F1 | | | | | | | | |
| Pectin | 92.2 ± 0.2 | 1.46 ± 0.02 | 6.37 ± 0.5 | 24.4 ± 0.5 | 0.397 ± 0.01 | ND | 8.6 ± 0.1 | 0.878 ± 0.01 |
| F3 | | | | | | | | |

Valencia Orange Peel 2

| | | | | | | | | |
|---|---|---|---|---|---|---|---|---|
| Pectin | 73.2 ± 0.3 | 2.41 ± 0.02 | 9.41 ± 0.5 | 191 ± 7 | 2.65 ± 0.04 | 29.4 ± 0.3 | 33.7 ± 0.3 | 0.611 ± 0.02 |
| F1 | | | | | | | | |
| Pectin | 74.3 ± 0.3 | 8.15 ± 0.07 | 118 ± 12 | 270 ± 2 | 0.351 ± 0.01 | 25.0 ± 0.3 | 27.5 ± 0.9 | 0.384 ± 0.01 |
| F3 | | | | | | | | |

Apple Fiber 1

| | | | | | | | | |
|---|---|---|---|---|---|---|---|---|
| Pectin | 69.0 ± 0.1 | 5.13 ± 0.1 | 79.3 ± 4.0 | 378 ± 0.6 | 0.646 | 29.7 ± 0.1 | 45.2 ± 0.8 | 0.469 ± 0.02 |
| F1 | | | | | 0.004 | | | |
| Pectin | 79.9 ± 3.0 | 2.70 ± 0.2 | 6.36 ± 0.6 | 88.7 ± 2.0 | 0.412 ± 0.01 | ND | 13.1 ± 0.2 | 0.588 ± 0.01 |
| F3 | | | | | | | | |

Apple Fiber 2

| | | | | | | | | |
|---|---|---|---|---|---|---|---|---|
| Pectin | 78.0 ± 0.5 | 4.06 ± 0.2 | 96.1 ± 14 | 146 ± 2 | 0.689 ± 0.007 | 27.9 ± 1.0 | 33.3 ± 4.0 | 0.525 ± 0.02 |
| F1 | | | | | | | | |
| Pectin | 78.4 ± 0.4 | 1.60 ± 0.04 | 8.16 ± 0.6 | 32.2 ± 0.5 | 0.342 ± 0.004 | ND | 9.7 ± 0.02 | 0.746 ± 0.02 |
| F3 | | | | | | | | |

Sugar Beet Pulp

| | | | | | | | | |
|---|---|---|---|---|---|---|---|---|
| Pectin | 69.9 ± 0.5 | 3.56 ± 0.1 | 27.2 ± 1.0 | 156 ± 2 | 0.874 ± 0.04 | 26.0 ± 1.0 | 26.4 ± 0.9 | 0.368 ± 0.02 |
| F1 | | | | | | | | |
| Pectin | 82.6 ± 0.3 | 2.54 ± 0.2 | 5.83 ± 0.5 | 59.0 ± 1.0 | 0.256 ± 0.008 | ND | 9.3 ± 0.2 | 0.597 ± 0.01 |
| F3 | | | | | | | | |

% Rec = percent recovery,
Mw/Mn, Mz/Mn = polydispersity,
Mwe\hat{ }3 = molar mass × 10-3,
Ivw = intrinsic viscosity,
Rgz = radius of gyration,
Rhzv = hydrodynamic radius,
a = Mark Houwink constant,
ND = Not Determined

TABLE 8
Demonstration of emulsion stability by measuring an
average particle size of oil-in-water emulsions prepared by
pectin fractions 1 and 3 isolated from orange peels, apple
fibers, and sugar beet pectin.

| | | | |
|---|---|---|---|
| Pectin Fractions | 0 Day | 3 Days | 7 Days |

Valencia Orange Peel 1

| | | | |
|---|---|---|---|
| Pectin, F1 | 42.94 ± 2.28 | 48.35 ± 3.51 | 50.23 ± 5.23 |
| Pectin, F3 | 8.69 ± 3.07 | 12.24 ± 0.04 | 23.99 ± 8.54 |

Valencia Orange Peel 2

| | | | |
|---|---|---|---|
| Pectin, F1 | 8.36 ± 2.16 | 17.65 ± 3.61 | 19.69 ± 0.78 |
| Pectin, F3 | 1.57 ± 0.16 | 2.61 ± 0.10 | 3.56 ± 0.80 |

Apple Fiber 1

| | | | |
|---|---|---|---|
| Pectin, F1 | 3.86 ± 0.30 | 4.57 ± 0.71 | 4.69 ± 0.86 |
| Pectin, F3 | 1.04 ± 0.04 | 1.12 ± 0.01 | 1.12 ± 0.07 |

Apple Fiber 2

| | | | |
|---|---|---|---|
| Pectin, F1 | 11.78 ± 5.78 | 17.18 ± 8.84 | 22.73 ± 6.10 |
| Pectin, F3 | 59.18 ± 1.24 | 68.58 ± 7.28 | 69.37 ± 2.05 |

Sugar Beet Pulp

| | | | |
|---|---|---|---|
| Pectin, F1 | 2.50 ± 0.09 | 3.41 ± 0.61 | 4.95 ± 1.56 |
| Pectin, F3 | 1.57 ± 0.07 | 4.72 ± 0.98 | 6.89 1.99 |

TABLE 9
Water holding capacity of cellulosic fraction F4 isolated
from orange peels, apple fibers and sugar beet pulp

| Sources | Water holding capacity (g water held/g sample) |
|---|---|
| Valencia Orange Peel 1 | 11.34 ± 0.66 |
| Valencia Orange Peel 2 | 43.39 ± 0.47 |
| Apple Fiber 1 | 40.05 ± 1.01 |
| Apple Fiber 2 | 30.78 ± 0.89 |
| Sugar Beet Pulp | 23.18 ± 1.23 |

Values are averages of triplicates. The numbers in parentheses indicate standard deviations.

TABLE 10
Uronic acid, degree of esterification and degree of acetylation

| | | | |
|---|---|---|---|
| | Uronic | Degree of | Degree of |
| Pectin | Acid (UA), | Esterification (DE), | Acetylation (DA), |
| Fractions | (Wt. %) | (Mole %) | (Mole %) |

Valencia Orange Peel 1

| | | | |
|---|---|---|---|
| Pectin, F1 | 43.3 ± 1.99 | 11.8 ± 1.87 | 0.30 ± 0.24 |
| Filtrate from | 3.4 ± 0.28 | | |
| Pectin F1 | | | |

Valencia Orange Peel 2

| | | | |
|---|---|---|---|
| Pectin, F1 | 50.3 ± 3.60 | 44.7 ± 1.61 | 1.5 ± 0.04 |
| Filtrate from | 15.1 ± 0.67 | | |
| Pectin F1 | | | |

Apple Fiber 1

| | | | |
|---|---|---|---|
| Pectin, F1 | 58.0 ± 1.15 | 26.0 ± 0.50 | 3.7 ± 0.20 |
| Filtrate from | 7.1 ± 0.24 | | |
| Pectin F1 | | | |

Apple Fiber 2

| | | | |
|---|---|---|---|
| Pectin, F1 | 55.3 ± 2.64 | 16.4 ± 1.83 | 0.2 ± 0.11 |
| Filtrate from | 5.7 ± 0.13 | | |
| Pectin F1 | | | |

Sugar Beet Pulp

| | | | |
|---|---|---|---|
| Pectin, F1 | 50.1 ± 1.89 | 42.0 ± 2.18 | 25.8 ± 0.09 |

TABLE 11
The rheological properties of the cellulosic
fraction F4 from the different sources

| | | Flow | |
|---|---|---|---|
| | Apparent | consistency | Flow |
| | viscosity at | index | behavior |
| Source | 1 s⁻¹ (cP) | K (Pa · sⁿ) | index n |
| Orange peel (Pepsico) | 1813.33 ± 90.73 | 2.425 | 0.377 |
| Orange peel (Valencia) | 53366.7 ± 666.65 | 68.662 | 0.163 |
| Apple pomace 40 mesh | 20966.7 ± 2554.08 | 28.531 | 0.234 |
| Apple pomace 60 mesh | 12800 ± 2251.66 | 19.099 | 0.227 |
| Sugar beet pulp | 14200 ± 2165.64 | 18.306 | 0.322 |

We claim:

1. A process for making pectin F1, said process comprising:
(1) removing oil from an agricultural by-product to form a de-oiled biomass,
(2) adding hot water with stirring to said de-oiled biomass and separating a hot water extracted biomass from said de-oiled biomass,
(3) removing water from said hot water extracted biomass to form a dry product,
(4) adding water to said dry product to form a suspension and adjusting the pH of said suspension to about 1.6,
(5) heating said suspension with stirring,
(6) cooling said suspension to about room temperature and separating said suspension to produce an acid extracted residue and an acid extracted filtrate,
(7) washing said acid extracted residue with water to form washings and a washed residue,
(8) combining said washings and said acid extracted filtrate to form combined filtrate and washings and adjusting the pH of said combined filtrate and washings to about 3 to about 3.2, and
(9) adding alcohol to said combined filtrate and washings to precipitate said pectin F1, and
(10) isolating said pectin F1.

2. A process for making pectin F2, said process comprising:
(1) removing oil from an agricultural by-product to form a de-oiled biomass,
(2) adding hot water with stirring to said de-oiled biomass and separating a hot water extracted biomass from said de-oiled biomass,
(3) removing water from said hot water extracted biomass to form a dry product,
(4) adding water to said dry product to form a suspension and adjusting the pH of said suspension to about 1.6,
(5) heating said suspension with stirring,
(6) cooling said suspension to about room temperature and separating said suspension to produce an acid extracted residue and an acid extracted filtrate,
(7) washing said acid extracted residue with water to form washings and a washed residue,
(8) rinsing said washed residue with an alcohol to form a rinsed residue,
(9) mixing said rinsed residue with water and adjusting the pH to about 6.8 and adding α-amylase to form a slurry,
(10) adjusting the pH of said slurry to about 11.5 and stirring,
(11) shearing said slurry,
(12) separating said slurry into an alkali insoluble solid residue and an alkali solubilized fraction which contains pectin F2 and pectin F3, and
(13) adjusting the pH of said alkali solubilized fraction to about 4 to form pectin F2, and
(14) isolating pectin F2.

3. A process for making pectin F3, said process comprising:
(1) removing oil from an agricultural by-product to form a de-oiled biomass,
(2) adding hot water with stirring to said de-oiled biomass and separating a hot water extracted biomass from said de-oiled biomass,
(3) removing water from said hot water extracted biomass to form a dry product,
(4) adding water to said dry product to form a suspension and adjusting the pH of said suspension to about 1.6,
(5) heating said suspension with stirring,
(6) cooling said suspension to about room temperature and separating said suspension to produce an acid extracted residue and an acid extracted filtrate,
(7) washing said acid extracted residue with water to form washings and a washed residue,
(8) rinsing said washed residue with an alcohol to form a rinsed residue,
(9) mixing said rinsed residue with water and adjusting the pH to about 6.8 and adding α-amylase to form a slurry,
(10) adjusting the pH of said slurry to about 11.5 and stirring,
(11) shearing said slurry,
(12) separating said slurry into an alkali insoluble solid residue and an alkali solubilized fraction which contains pectin F2 and pectin F3, and
(13) adjusting the pH of said alkali solubilized fraction to about 4 which precipitates pectin F2, and
(14) isolating pectin F3 from pectin F2.

4. A process for making acid and alkali soluble materials, said process comprising:
(1) removing oil from an agricultural by-product to form a de-oiled biomass,
(2) adding hot water to said de-oiled biomass and separating a hot water extracted biomass from said de-oiled biomass,
(3) removing water from said hot water extracted biomass to form a dry product,
(4) adding water to said dry product to form a suspension and adjusting the pH of said suspension to about 1.6,
(5) heating said suspension with stirring,
(6) cooling said suspension to about room temperature and separating said suspension to produce an acid extracted residue and an acid extracted filtrate,
(7) washing said acid extracted residue with water to form washings and a washed residue,
(8) rinsing said washed residue with an alcohol to form a rinsed residue,
(9) mixing said rinsed residue with water and adjusting the pH to about 6.8 and adding α-amylase to form a slurry,
(10) adjusting the pH of said slurry to about 11.5 and stirring,
(11) shearing said slurry,
(12) separating said slurry into an alkali insoluble solid residue and an alkali solubilized fraction which contains pectin F2 and pectin F3,
(13) adjusting the pH of said alkali solubilized fraction to about 4, (14) centrifuging or filtering said alkali solubilized fraction to separate and isolate pectin F2 from the supernatant or filtrate containing pectin F3,
(15) adding alcohol to said supernatant or filtrate to form a first precipitate and first decantant,
(16) removing said first precipitate and adding alcohol to form a second precipitate and second decantant, and
(17) combining said first decantant and said second decantant which contains said acid and alkali soluble materials.

5. A process for making cellulosic fraction F4, said process comprising:
(1) removing oil from an agricultural by-product to form a de-oiled biomass,
(2) adding hot water with stirring to said de-oiled biomass and separating a hot water extracted biomass from said de-oiled biomass,
(3) removing water from said hot water extracted biomass to form a dry product,
(4) adding water to said dry product to form a suspension and adjusting the pH of said suspension to about 1.6,
(5) heating said suspension with stirring,
(6) cooling said suspension to about room temperature and separating said suspension to produce an acid extracted residue and an acid extracted filtrate,
(7) washing said acid extracted residue with water to form washings and a washed residue,
(8) rinsing said washed residue with an alcohol to form a rinsed residue,
(9) mixing said rinsed residue with water and adjusting the pH to about 6.8 and adding α-amylase to form a slurry,
(10) adjusting the pH of said slurry to about 11.5 and stirring,
(11) shearing said slurry,
(12) separating said slurry into an alkali insoluble solid residue and an alkali solubilized fraction which contains pectin F2 and pectin F3,
(13) suspending said alkali insoluble solid residue in boiling water and stirring,
(14) shearing said alkali insoluble solid residue to form a first sheared material,
(15) cooling said first sheared material to about room temperature and centrifuging to separate solid residue 1,
(16) suspending said solid residue 1 in boiling water and stirring,
(17) shearing said solid residue 1 to form a second sheared material,
(18) centrifuging said second sheared material to separate solid residue 2,
(19) suspending said solid residue 2 in boiling water and stirring,
(20) shearing said solid residue 2 to form a third sheared material,
(21) centrifuging said third sheared material to separate solid residue 3,
(22) suspending said solid residue 3 in boiling water and stirring,
(23) shearing said solid residue 3 to form a fourth sheared material, and
(24) cooling said fourth sheared material to about room temperature and centrifuging to separate and isolate solid residue 4 which contains cellulosic fraction F4.

6. A process for making a hot water extract, said process comprising:
(1) removing oil from an agricultural by-product to form a de-oiled biomass,
(2) adding hot water with stirring to said de-oiled biomass and separating a hot water extracted biomass and a liquid filtrate from said de-oiled biomass, and
(3) removing water from said liquid filtrate to form said hot water extract.

7. A process for making materials having a molecular weight less than 30 KDa, said process comprising:
(1) removing oil from an agricultural by-product to form a de-oiled biomass,
(2) adding hot water with stirring to said de-oiled biomass and separating a hot water extracted biomass from said de-oiled biomass,
(3) removing water from said hot water extracted biomass to form a dry product,
(4) adding water to said dry product to form a suspension and adjusting the pH of said suspension to about 1.6,
(5) heating said suspension with stirring,
(6) cooling said suspension to about room temperature and separating said suspension to produce an acid extracted residue and an acid extracted filtrate,
(7) washing said acid extracted residue with water to form washings and a washed residue,
(8) combining said washings and said acid extracted filtrate to form combined filtrate and washings and adjusting the pH of said combined filtrate and washings to about 3 to about 3.2, and
(9) adding alcohol to said combined filtrate and washings to precipitate said pectin F1,
(10) isolating said pectin F1 to form isolated pectin F1 and a final filtrate, and
(11) evaporating said final filtrate to from materials having a molecular weight less than 30 KDa.

8. Pectin F1, said pectin F1 produced by the process of claim 1.

9. Pectin F2, said pectin F2 produced by the process of claim 2.

10. Pectin F3, said pectin F3 produced by the process of claim 3.

11. Acid and alkali soluble materials, said acid and alkali soluble low molecular weight materials produced by the process of claim 4.

12. Cellulosic fraction F4, said cellulosic fraction F4 produced by the process of claim 5.

13. How water extract, said hot water extract produced by the process of claim 6.

14. Materials having a molecular weight less than 30 KDa, said materials produced by the process of claim 7.
